(19) United States
(12) Patent Application Publication
(10) Pub. No.: US 2026/0108906 A1
(43) Pub. Date: Apr. 23, 2026

(54) BOTTLE ACCOMMODATING APPARATUS AND BOTTLE ACCOMMODATING METHOD

(71) Applicant: Tokyo Electron Limited, Tokyo (JP)

(72) Inventors: Takara KOGANEZAWA, Kumamoto (JP); Akira OOZONO, Kumamoto (JP); Masashi TSUCHIYAMA, Kumamoto (JP); Shinsuke TAKAKI, Kumamoto (JP); Yuta NISHIYAMA, Kumamoto (JP); Ryuto NAGAMOTO, Kumamoto (JP); Ryota HATTORI, Kumamoto (JP)

(21) Appl. No.: 19/363,034

(22) Filed: Oct. 20, 2025

(30) Foreign Application Priority Data
Oct. 21, 2024 (JP) 2024-185278

(51) Int. Cl. B05C 11/10

(52) U.S. Cl. CPC B05C 11/10

(57) ABSTRACT

A bottle accommodating apparatus includes: a bottle mounting stage on which a bottle storing a processing liquid for manufacturing a semiconductor device is mounted; and a switcher configured to switch between a first state in which a space around the bottle mounting stage is closed and a second state in which the space is open so that the bottle is delivered to and from the bottle mounting stage.

### CROSS-REFERENCE TO RELATED APPLICATION

This application is based upon and claims the benefit of priority from Japanese Patent Application No. 2024-185278, filed on Oct. 21, 2024, the entire contents of which are incorporated herein by reference.

### TECHNICAL FIELD

The present disclosure relates to a bottle accommodating apparatus and a bottle accommodating method.

### BACKGROUND

In a manufacturing process of semiconductor devices, liquid processing is performed by supplying processing liquids such as a resist, a coating liquid for forming an anti-reflection film, a solvent, and a precursor-containing liquid for forming an insulating film from a nozzle to a substrate. As an apparatus for supplying such processing liquids to perform processing, Patent Document 1 discloses a resist coating apparatus.

The resist coating apparatus includes a tank for storing a chemical solution. A nozzle is connected to the tank via a supply path, and the chemical solution is supplied from the nozzle to the substrate. In addition, the chemical solution is supplied to the tank from a chemical solution bottle containing the chemical solution.

### Prior Art Documents

### Patent Documents

Patent Document 1: Japanese Laid-Open Patent Publication No. 2016-189493

### SUMMARY

According to one embodiment of the present disclosure, a bottle accommodating apparatus includes a bottle mounting stage on which a bottle storing a processing liquid for manufacturing a semiconductor device is mounted; and a switcher configured to switch between a first state in which a space around the bottle mounting stage is closed and a second state in which the space is open so that the bottle is delivered to and from the bottle mounting stage.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a plane view showing a wafer processing system, including a bottle accommodating apparatus, according to a first embodiment.

FIG. 2 is a front view showing the bottle accommodation device.

FIG. 3 is a configuration diagram showing a processing liquid supply system.

FIG. 4 is a vertical cross-sectional view showing a configuration example of a housing and a bottle mounting stage.

FIG. 5 is a vertical cross-sectional view showing a configuration example of the bottle mounting stage.

FIG. 6 is a plane view schematically showing a bottle and a tank in a first state.

FIG. 7 is a vertical cross-sectional view showing a configuration example of the bottle mounting stage in the first state.

FIG. 8 is a vertical cross-sectional view showing a configuration example of the bottle mounting stage in a second state.

FIG. 9 is a vertical cross-sectional view showing a portion of the bottle mounting stage.

FIG. 10 is a vertical cross-sectional view showing a portion of the bottle mounting stage.

FIG. 11 is a plane view schematically showing an operation of the bottle accommodating apparatus.

FIG. 12 is a vertical cross-sectional view showing a wafer processing system, including a bottle accommodating apparatus, according to a second embodiment.

FIG. 13 is a side view showing the bottle accommodating apparatus.

FIG. 14 is a vertical cross-sectional view showing a portion of the bottle accommodating apparatus.

FIG. 15 is a plane view schematically showing an operation of the bottle accommodating apparatus.

FIG. 16 is a plane view showing a wafer processing system, including a bottle accommodating apparatus, according to a third embodiment.

FIG. 17 is a plane view schematically showing a wafer processing system, including a bottle accommodating apparatus, according to a fourth embodiment.

FIG. 18 is a plane view showing a wafer processing system, including a bottle accommodating apparatus, according to a fifth embodiment.

FIG. 19 is a perspective view showing a configuration example of a first space and a bottle mounting stage.

FIG. 20 is a plane view schematically showing a configuration example of the first space.

FIG. 21 is a plane view schematically showing a configuration example of the first space.

FIG. 22 is a plane view schematically showing a configuration example of the first space.

FIG. 23 is a plane view schematically showing an operation of the bottle accommodating apparatus.

FIG. 24 is a vertical cross-sectional view showing a configuration example of a housing and a bottle mounting stage.

FIG. 25 is a perspective view showing a configuration example of a first detector and a second detector.

FIG. 26 is a side view showing a configuration example of the first detector and the second detector.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Hereinafter, a wafer processing system as a bottle accommodating apparatus according to the present embodiment is described with reference to the drawings. In the present disclosure, elements having substantially the same functional configuration are designated by the same reference numerals, and the repeated description thereof is omitted.

### Wafer Processing System

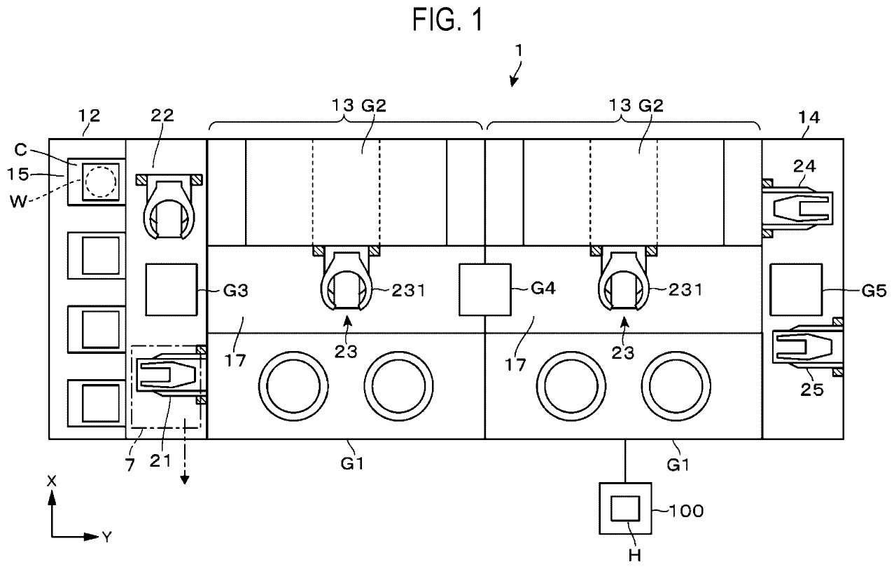

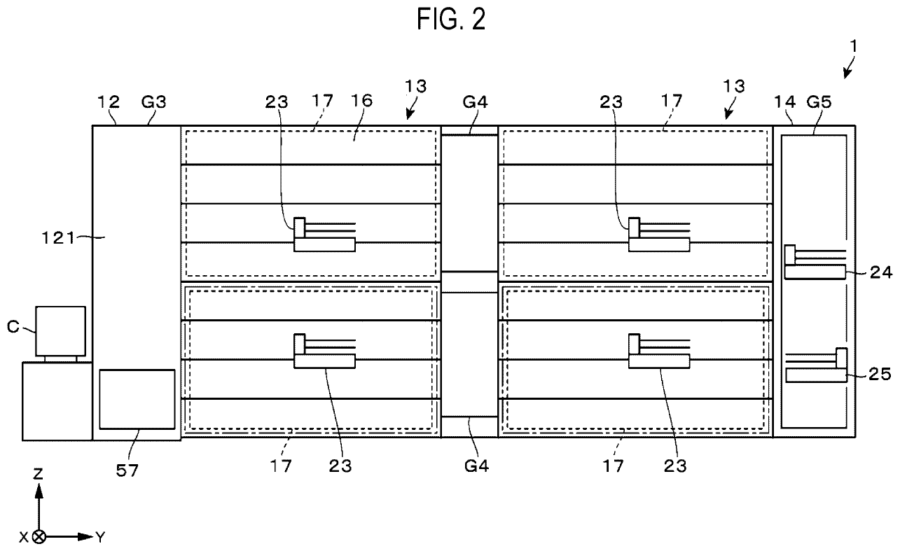

First, a configuration of the wafer processing system according to the embodiment is described. FIGS. 1 and 2 are a plane view and a front view, respectively, schematically showing the overall configuration of the wafer processing system 1. In this embodiment, a case where the wafer processing system 1 is a photolithography processing system that performs a resist film formation process and a development process on a wafer W is described as an example.

As shown in FIG. 1, the wafer processing system 1 includes a cassette station 12, which constitutes a substrate loading/unloading block through which cassettes C accommodating a plurality of wafers W are loaded and unloaded, and a processing station 13, which constitutes a processing block including a plurality of processing apparatuses for performing predetermined processes on the wafers W. The wafer processing system 1 is configured by integrally connecting the cassette station 12, the processing station 13, and an interface station 14 which delivers the wafers W to and from an exposure apparatus (not shown) adjacent to the interface station 14 on a side opposite from the processing station 13. While two processing stations 13 are installed between the cassette station 12 and the interface station 14 as shown in FIG. 1, one processing station 13 or three or more processing stations 13 may be installed. Hereinafter, a direction in which the cassette station 12 and the processing station 13 are arranged side by side is referred to as a left-right direction (Y direction in FIGS. 1 and 2), and a direction orthogonal to the left-right direction is referred to as a front-rear direction (X direction in FIGS. 1 and 2). In addition, in the left-right direction, a side on which the cassette station 12 is located is referred to as a left side, and a side on which the processing station 13 is located is referred to as a right side. Further, when the cassette station 12 is seen on the left and the processing station 13 is seen on the right in the front-rear direction, a near side is referred to as a front side and a far side is referred to as a rear side.

The cassette station 12 is provided with a plurality of cassette mounting tables 15 and a plurality of wafer transfer devices 21 and 22. The cassette station 12 uses the wafer transfer device 21 or 22 to transfer wafers between the cassette C mounted on the cassette mounting table 15 and the processing station 13. To this end, each of the wafer transfer devices 21 and 22 includes drivers respectively having movement paths in various directions, such as a horizontal direction (X direction and Y direction), an up-down direction (Z direction), and a direction around a vertical axis (θ direction), as needed, or may be provided with a driver having movement paths in all directions. In this example, the cassette mounting table 15 corresponds to a container mount, and the wafer transfer device 21 or 22 corresponds to a transferrer.

At least one selected from the group of the wafer transfer devices 21 and 22 is able to deliver the wafers to and from the cassette C, and is also able to deliver the wafers to and from the processing station 13. Delivering the wafers to and from the processing station 13 refers to delivering the wafers to and from a third block G3, which includes a delivery device accessible by a wafer transfer device 23 in the processing station 13 to be described later. The third block G3 may include a plurality of delivery devices (not shown) arranged in the up-down direction. An inspection device (not shown) for inspecting the wafers W may be provided at a position accessible by either of the wafer transfer devices 21 and 22.

The processing station 13 includes a plurality of blocks, e.g., three blocks G1, G2, and G4 (first, second, and fourth blocks). As shown in FIG. 2, a plurality of floors 16 each including the first and second blocks G1 and G2 are stacked in the up-down direction. For example, the first block G1 is provided on a front side of the processing station 13 (a negative X-direction in FIG. 1), and the second block G2 is provided on a rear side of the processing station 13 (a positive X-direction in FIG. 1). The fourth block G4 is provided on an interface station 14 side of the processing station 13 (a positive Y-direction in FIG. 1) or at a connection portion with another adjacent processing station 13. The fourth block G4 may include a plurality of delivery devices arranged in the up-down direction. The aforementioned third block G3 may also be provided within the processing station 13.

In the first block G1, a plurality of processing apparatuses, such as a patterning film forming apparatus or a developing apparatus (not entirely shown) are disposed. The patterning film forming apparatus may include, for example, a resist film forming apparatus and an anti-reflection film forming apparatus. The plurality of processing apparatuses may be arranged in the horizontal direction. The number, disposition, and type of these processing apparatuses may be selected arbitrarily.

In the patterning film forming apparatus or the developing apparatus, for example, a predetermined processing liquid or a predetermined gas is supplied onto the wafers W. In this manner, the patterning film forming apparatus forms a resist film used as a mask when forming a pattern on an underlying film, or forms an anti-reflection film for efficiently performing a light irradiation process, such as an exposure process. On the other hand, in the developing apparatus, a portion of the exposed resist film is removed to form an uneven shape that serves as the mask.

In addition, for example, in the second block G2, heat treatment apparatuses (not shown) that perform heat treatments such as heating and cooling of the wafers W are provided in the up-down direction and the horizontal direction. Further, in the second block G2, although not shown, hydrophobization treatment apparatuses that perform a hydrophobization treatment to improve fixation of a resist liquid to the wafers W, and peripheral exposure apparatuses that expose peripheral portions of the wafers W are provided in the up-down direction (Z direction in FIG. 2) and the horizontal direction. The number and disposition of these heat treatment apparatuses, hydrophobization treatment apparatuses, and peripheral exposure apparatuses may also be selected arbitrarily.

As shown in FIG. 1, a wafer transfer region 17 is formed in a region sandwiched between the first block G1 and the second block G2 in a plane view. For example, the wafer transfer device 23 is disposed in the wafer transfer region 17. The wafer transfer device 23 includes a transfer arm 231 that is movable in, for example, the X, Y, Z, and θ directions. The wafer transfer device 23 moves within the wafer transfer region 17 and is able to transfer the wafers W to predetermined apparatuses in the surrounding first block G1, second block G2, third block G3, and fourth block G4. When a plurality of processing stations 13 are provided as shown in FIG. 1, the wafer transfer device 23 provided in the processing station 13 located on the interface station 14 side is able to transfer the wafers W to predetermined apparatuses in the first, second, and fourth blocks G1, G2, and G4, as well as a fifth block G5 to be described later.

A plurality of wafer transfer devices 23 are disposed in the up-down direction, for example, as shown in FIG. 2. One wafer transfer device 23 is able to transfer the wafers W to a predetermined apparatus located at a height of upper floors 16 among the plurality of floors 16 stacked in the up-down direction. Another wafer transfer device 23 is able to transfer wafers W to a predetermined apparatus located at a height of lower floors 16 located below the upper floors 16. A plurality of wafer transfer regions 17 are provided to enable such transfer of the wafers W. The number of wafer transfer devices 23 and the number of floors 16 corresponding to one wafer transfer device 23 may be selected arbitrarily, for example, by providing the wafer transfer device 23 for each floor 16.

The wafer transfer region 17, the first block G1, or the second block G2 may also include a shuttle transfer device (not shown). The shuttle transfer device linearly transfers wafers W between a space adjacent to one side of the processing station 13 and another space adjacent to an opposite side.

The interface station 14 is provided with the fifth block G5 including a plurality of delivery devices, and wafer transfer devices 24 and 25. The interface station 14 transfers the wafer W between the fifth block G5 where the wafer W is delivered by the wafer transfer device 23, and the exposure apparatus by using the wafer transfer device 24 or 25. To this end, each of the wafer transfer devices 24 and 25 is provided with drivers having movement paths in respective directions, such as the X direction, Y direction, Z direction, and θ direction, as needed, or may be provided with a driver having movement paths in all directions. At least one selected from the group of the wafer transfer devices 24 and 25 is able to support the wafer W and transfer the wafer W between the delivery device in the fifth block G5 and the exposure apparatus.

A cleaning apparatus for cleaning the surface of the wafer W or the aforementioned peripheral exposure apparatus may be provided in the interface station 14, at a position accessible by either of the wafer transfer devices 24 and 25. The inspection device may be included in the cassette station 12 as described above, but may also be included in the processing station 13 and the interface station 14, at a position accessible by either of the transfer arms (23, 24, and 25 in FIG. 1 or 2) provided in the processing station 13 and the interface station 14.

The wafer processing system 1 described above is provided with a controller 100, which serves as a control part. The controller 100 is, for example, a computer, and includes a program storage (not shown). The program storage stores a program for controlling processing of the wafers W in the wafer processing system 1. The program storage also stores a program for controlling operations of drive systems for the various processing apparatuses and transfer devices described above to realize wafer processing in the wafer processing system 1. The program includes a set of steps required to transfer and process the wafers W in the wafer processing system 1, and the program causes the controller 100 to output control signals to the respective parts of the wafer processing system 1 and control the respective parts as described above to perform the transfer and processing.

The program may be recorded on a computer-readable storage medium H and installed into the controller 100 from the storage medium H. The storage medium H may include a ROM, a RAM, or a hard disk, but a structure and a type of the storage medium H are not limited. The storage medium H may be transitory or non-transitory. The controller 100 may include a section that stores, reads, and executes a program for executing the wafer processing and performs related communications. In addition, each section may be located inside or outside the wafer processing system 1. The controller 100 may be one or more circuits, or may be provided as an integrated unit or as separate parts.

### Operation of Wafer Processing System

Next, an example of the wafer processing performed by using the wafer processing system 1 configured as above is described. First, a cassette C accommodating a plurality of wafers W is loaded into the cassette station 12 and placed on the cassette mounting table 15. Next, each wafer W in the cassette C is sequentially taken out by the wafer transfer device 21 or 22 and transferred to the delivery device in the third block G3.

The wafer W transferred to the delivery device in the third block G3 is supported by the wafer transfer device 23 and transferred to the hydrophobization treatment apparatus provided in the second block G2, where the wafer W is subjected to a hydrophobization treatment. The wafer W is then transferred by the wafer transfer device 23 to the resist film forming apparatus where a resist film is formed on the wafer W, then transferred to the heat treatment apparatus where the wafer W is pre-baked, and then transferred to the delivery device in the fifth block G5. When there are a plurality of processing stations 13 as shown in FIGS. 1 and 2, the wafer W is temporarily placed in the delivery device in the fourth block G4 before being transferred to the delivery device in the fifth block G5, and then delivered to and from the plurality of wafer transfer devices 23. In addition, if necessary, the wafer W may also be transferred by the wafer transfer device 23 to the peripheral exposure apparatus where a peripheral edge of the wafer is subjected to an exposure process.

The wafer W transferred to the delivery device in the fifth block G5 is transferred to the exposure apparatus by the wafer transfer devices 24 and 25 where the wafer W is subjected to an exposure process in a predetermined pattern. The wafer W may be cleaned in a cleaning apparatus before the exposure process. The exposed wafer W is transferred to the delivery device in the fifth block G5 by the wafer transfer devices 24 and 25. Thereafter, the wafer W is transferred to a heat treatment apparatus by the wafer transfer device 23 where the wafer W is subjected to a post-exposure baking process.

After the exposure and baking processes, the wafer W is transferred by the wafer transfer device 23 to a developing apparatus where the wafer W is developed. After the developing is completed, the wafer W is transferred by the wafer transfer device 23 to a heat treatment apparatus where the wafer W is post-baked. The wafer W is then transferred by the wafer transfer device 23 to the delivery device in the third block G3, and then transferred by the wafer transfer device 21 or 22 of the cassette station 12 to a cassette C of a predetermined cassette mounting table 15. This completes a series of photolithography processes.

The wafer processing system of the present disclosure is not limited to the configuration and operations described above. For example, in the above-described embodiment, the wafer processing system is directly connected to the exposure apparatus, and the wafers W are delivered between the interface station 14 and the exposure apparatus. However, the wafer processing system does not have to be directly connected to the exposure apparatus. In that case, for example, the wafer W is transferred from the cassette station 12 to the processing station 13, subjected to necessary processing, and then transferred back to the cassette station 12 for unloading from the system. Further, unnecessary processing apparatuses among the processing apparatuses listed above may not be provided in the wafer processing system, or processing may not be performed in the unnecessary processing apparatuses.

### Processing Liquid Supply System

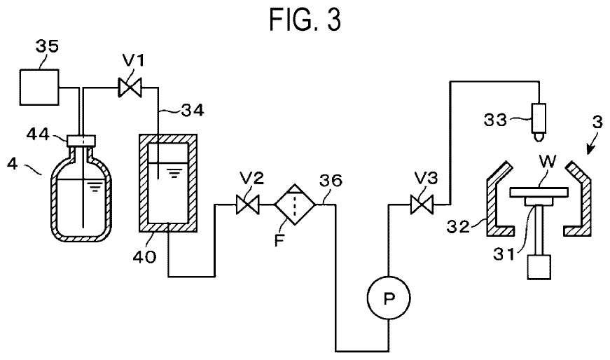

Next, referring to FIG. 3, a processing liquid supply system in the processing apparatuses such as the resist film forming apparatus and the developing apparatus is briefly described. These processing apparatuses constitute liquid processors which are supplied with a processing liquid to perform liquid processing on the wafers W. FIG. 3 shows a resist film forming apparatus 3 as an example of the processing apparatuses. The resist film forming apparatus 3 includes a nozzle 33 for supplying a resist, which is a processing liquid, to a center of the wafer W held by a spin chuck 31 and surrounded by a cup 32.

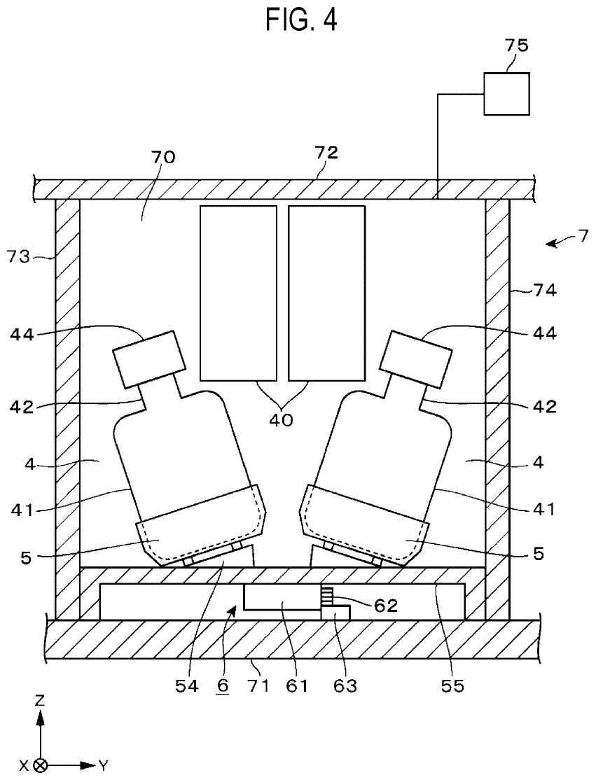

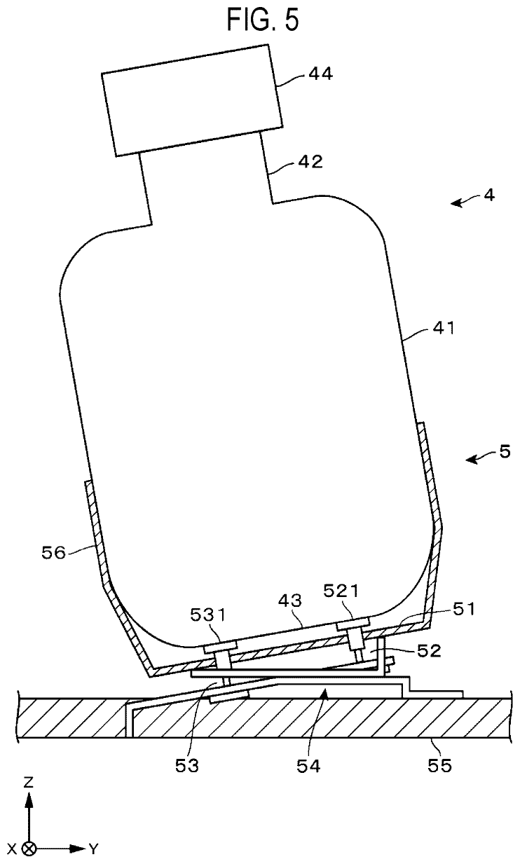

The nozzle 33 is supplied with a resist liquid, which is a processing liquid, from a supply source for the resist liquid. The supply source of the resist liquid includes a bottle 4 and a tank 40 in which the resist liquid is stored. The bottle 4 is a sealed bottle for storing the resist liquid, and as shown in FIGS. 4 and 5, for example, includes a body 41 in which the resist liquid is stored, a neck 42 located above the body 41, and a flat bottom surface 43. The neck 42 has an outer shape that is narrower than an outer shape of the body 41. In this example, the body 41 and the neck 42 are configured as concentric circles in a plane view, and a diameter of the neck 42 is smaller than a diameter of the body 41. Therefore, the neck 42 is formed to form a step with the body 41. An upper end of the neck 42 is open, and a cap 44 is provided to open and close the opening.

The bottle 4 is connected to the tank 40 via a flow path 34 including a valve V1, and an upstream end of the flow path 34 extends via a cap 44 to a vicinity of the bottom surface 43 of the bottle 4. An inert gas for pressurization, such as a nitrogen (N₂) gas, is supplied from an inert gas supplier 35 into the bottle 4 via the cap 44. Further, the tank 40 is connected to the nozzle 33 via a flow path 36 including a valve V2, a filter F, a pump P, and a valve V3, in the named order from an upstream side.

In this supply system, by supplying the inert gas to the bottle 4 and pressurizing the bottle 4, the resist liquid in the bottle 4 is supplied into the tank 40 and into the flow path 36 downstream of the tank 40. Further, the resist liquid in the tank 40 is then supplied to the nozzle 33 via the flow path 36 by driving the pump P, and is then injected from the nozzle 33 onto the wafer W on the spin chuck 31. At this time, foreign substances (particles) contained in the resist liquid flowing from an upstream side to a downstream side of the flow paths 34 and 36 are collected by the filter F provided in the flow path 36 and removed from the resist liquid.

In this example, the supply system of the resist film forming apparatus 3 has been described as an example, but in the wafer processing system 1, the bottle 4 for storing a processing liquid and the tank 40 for receiving the processing liquid stored in the bottle 4 are provided for each processing liquid used to manufacture semiconductor devices. Examples of the processing liquid include a resist liquid, a chemical liquid for forming an anti-reflection film, a chemical liquid for forming an insulating film, a developing liquid for performing a developing process, a thinner, and other solvents. Therefore, multiple bottles 4 and tanks 40 are disposed in one wafer processing system 1.

The bottle 4 is disposed within the wafer processing system 1, and when, for example, all of the processing liquid in the bottle 4 has been supplied to the tank 40, the empty bottle 4 is replaced with a new bottle 4 filled with a processing liquid. There is a need to reduce labor required by an operator when performing this replacement operation. Therefore, the wafer processing system 1, which includes the bottle accommodating apparatus, is configured to be switched by a switcher between a first state in which a space around a bottle mounting stage 5 on which the bottle 4 is mounted is closed, and a second state in which the space is open so that the bottle 4 is delivered.

### First Embodiment

Next, a wafer processing system 1 provided with the bottle mounting stage 5 according to a first embodiment of the present disclosure is described with reference to FIGS. 4 to 11. In this embodiment, the wafer processing system 1 includes a housing 7 that surrounds the bottle mounting stage 5 in the first state. The housing 7 is provided in the cassette station 12.

As indicated by a one-dot chain line in FIG. 1, the housing 7 is disposed in the cassette station 12 below a region in which, for example, the wafer transfer device 21 is provided. In this example, the bottle mounting stage 5 is configured to move between a first state in which the bottle mounting stage 5 is located inside the housing 7 and a second state in which the bottle mounting stage 5 is located in front of the housing 7 as indicated by a one-dot chain line arrow in FIG. 1. The bottle 4 is then delivered to and from the bottle mounting stage 5 in the second state.

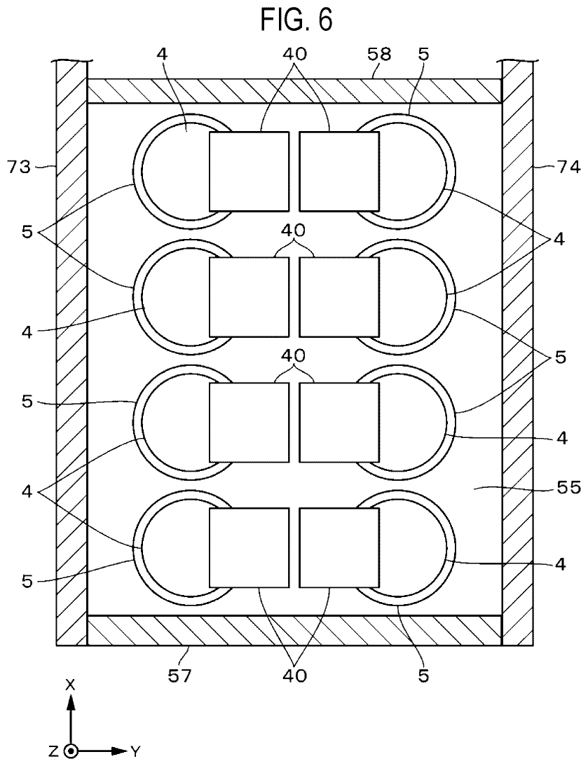

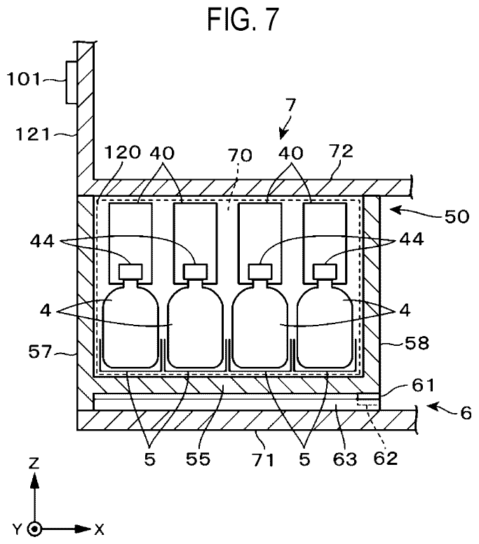

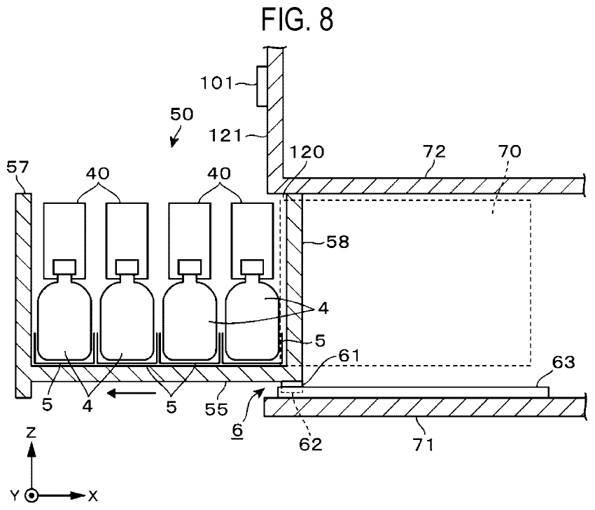

An overview of the housing 7 is described. FIG. 4 is a vertical cross-sectional view of the housing 7 as seen from the front, FIG. 6 is a plane view of the housing 7 as seen from above, and FIGS. 7 and 8 are vertical cross-sectional views of the housing 7 as seen from a side of the processing station 13. Each of the stations described above, including the cassette station 12, includes its own housing, and the processing apparatuses and the wafer transfer devices described above are provided in the housing (hereinafter referred to as a system housing to distinguish it from the housing 7). The system housing of the cassette station 12 is provided with partition walls (top wall 72 and side walls 73 and 74 shown in FIG. 4) fixed to the system housing. These partition walls form the housing 7, which surrounds the bottle mounting stages 5 and the bottles 4 within the cassette station 12. A space 70 within the housing 7 is a space separated from spaces in which the processing apparatuses and the wafer transfer devices 21 and 22 are provided.

A portion of a side wall of the system housing (plate-like body 57 shown in FIGS. 7 and 8) constitutes a lid for the housing 7. This lid is movable in the front-rear direction and is switchable between a state in which the lid is in contact with and integral with another portion of a side wall of the system housing (wall 121 shown in FIGS. 7 and 8) and a state in which the lid is separated from the another portion of the side wall. The bottle mounting stage 5 and the bottle 4 are also configured to move according to the movement of the lid. As shown in FIG. 7, when the plate-like body 57 serving as the lid is connected to the wall 121, a space 70 within the housing 7 is formed as a sealed space. As the bottle mounting stage 5 and the bottle 4 are positioned in the space 70, the space around the bottle mounting stage 5 and the bottle 4 is closed by the housing 7. That is, this state is the first state described above.

As shown in FIG. 8, when the plate-like body 57 is separated from the wall 121, the space 70 is open to a space outside the system housing (a space inside the clean room in which the wafer processing system 1 is provided), and the bottle mounting stage 5 and the bottle 4 are located in front of the partition wall that forms the housing 7. Therefore, in this state, the bottle mounting stage 5 and the bottle 4 are located outside the space 70, and are kept in the second state in which the space around the bottle mounting stage 5 and the bottle 4 is open to the space inside the clean room, making it possible to replace the bottle 4.

The housing 7 is described in more detail. FIG. 4 is a diagram showing the first state in which the bottle 4 is mounted on the bottle mounting stage 5 and the space around the bottle mounting stage 5 is enclosed by the housing 7. In this example, a bottom wall 71, the top wall 72, and the side walls 73 and 74 of the housing 7 are provided in the cassette station 12 as described above. As shown in FIGS. 4 and 5, the bottle mounting stage 5 is a bowl-shaped container that is open at the top, and is configured to receive a lower side of the bottle 4 and support the bottle 4 in a tilted state. As shown in FIG. 4, two bottle mounting stages 5 are arranged side by side when viewed from the front, and the two bottles 4 are mounted on the bottle mounting stages 5 such that the bottles 4 move away from each other as they extend upward with their necks 42 inclined outward.

The reason why the bottle 4 is mounted on the bottle mounting stage 5 in such a tilted state is to tilt the bottle 4 to collect the processing liquid stored in the bottle 4 when supplying the processing liquid to the tank 40. More specifically, the reason is to locate a lower end of a tube constituting the flow path 34 described in FIG. 3 at a position where the processing liquid is collected, so that it is possible to send the processing liquid to the tank 40 even when there is only a small amount of the processing liquid in the bottle 4. The second reason is to ensure that when the bottle mounting stage 5 is set to the second state to deliver the bottle 4, the necks 42 of the bottles 4 are disposed on outer sides in the left-right direction, thereby making it easy to replace the bottles from the left-right direction.

For this reason, as shown in FIG. 5, a bottom surface 51 of the bottle mounting stage 5 is formed to face the bottom surface 43 of the bottle 4 and is configured as an inclined surface that is inclined so as to tilt and mount the bottle 4. FIG. 5 shows the left bottle mounting stage 5 of the two bottle mounting stages 5 shown in FIG. 4. In addition, a first support 52 and a second support 53 that each support the bottom surface 43 of the bottle 4 are provided at different heights on the inclined bottom surface 51. More specifically, the first support 52 and the second support 53 include contact portions 521 and 531 that contact the bottom surface 43 of the bottle 4, and positions of the contact portions 521 and 531 on the inclined surface (bottom surface 51) differ between the first support 52 and the second support 53.

The contact portion 521 of the first support 52 and the contact portion 531 of the second support 53 are arranged side by side along the inclined bottom surface 51 when viewed from the front. The contact portion 521 of the first support 52 is located higher than the contact portion 531 of the second support 53, and the first support 52 includes a detector, which is described later. In this example, the bottom surface 51 of the bottle mounting stage 5 is circular, and two first supports 52 and two second supports 53 are provided at positions spaced apart in the front-rear direction. However, only one of the first supports 52 and only one of the second supports 53 are shown in FIG. 5. The first supports 52 and the second supports 53 are installed on a horizontal support body 55 having a rectangular shape in a plane view by a support member 54.

As described above, the bottle mounting stage 5 is a bowl-shaped container, and a side surface 56 of this container is approximately perpendicular to the bottom surface 51. The side surface 56 is formed slightly larger than an outer shape of the bottle 4 so as to cover the lower side of the bottle 4 and support the lower side of the bottle 4 in a tilted direction (a left direction in FIG. 5) when the bottle 4 is supported in a normal posture by the first support 52 and the second support 53. In this way, the bottle 4 is mounted on the bottle mounting stage 5 with its position in the tilted direction restricted.

In FIG. 4, a left-hand position of the bottle 4 on a left side is restricted by the bottle mounting stage 5, and a right-hand position of the bottle 4 on a right side is restricted by the bottle mounting stage 5. The state in which the bottle 4 is mounted on the bottle mounting stage 5 in this posture is a state in which the bottle 4 is mounted in the normal posture. An area occupied by the bottle 4 in this state is referred to as a bottle disposition area. Hereinafter, mounting the bottle 4 on the bottle mounting stage 5 may also be referred to as disposing the bottle 4 in the bottle disposition area.

In this example, as schematically shown in FIG. 6, two bottle mounting stages 5 are arranged in the left-right direction (Y direction) and a plurality of bottle mounting stages 5, for example, four bottle mounting stages 5, are arranged in the front-rear direction (X direction) at intervals on the support body 55. More specifically, the bottle mounting stages 5 are arranged in rows on left and right sides of the support body 55 when viewed in the front-rear direction, and arranged in four rows in the front-rear direction when viewed from the left-right direction.

As shown in FIGS. 4 and 6, when the bottles 4 are disposed in the bottle disposition area, tanks 40 corresponding to the respective bottles 4 are supported by support members (not shown) above the two bottles 4 provided side by side as viewed from the front. In this example, the tanks 40 are provided more inward in the left-right direction as viewed from the front, compared to the bottles 4 in the bottle disposition area. These bottles 4 and tanks 40 are connected by flow paths 34 (not shown). As described above, the processing liquid in the bottles 4 is supplied to the tanks 40 by supplying a pressurizing inert gas from the inert gas supplier 35 (not shown) into the bottles 4.

The disposition of the tanks 40 and the bottles 4 in the bottle disposition area is described in more detail. The tank 40 is provided for each bottle 4, and is disposed adjacent to the bottle 4 from which the processing liquid is supplied. The tanks 40 to which the processing liquid is supplied from the bottles 4 in the left row are provided to the right of the necks 42 of these bottles 4, and the tanks 40 to which the processing liquid is supplied from the bottles 4 in the right row are provided to the left of the necks 42 of these bottles 4.

By providing the tanks 40 in this manner, similarly to the bottle mounting stages 5, the tanks 40 are also arranged in rows on the left and right sides of the support body 55. Lower sides of the respective tanks 40 arranged in rows in this manner are located in a space between a row formed by the necks 42 of the bottles 4 on the left side and a row formed by the necks 42 of the bottles 4 on the right side, and the lower sides of the tanks 40 arranged side by side in the left-right direction are sandwiched in the left-right direction between the necks 42 of the bottles 4 that supply the processing liquid to the tanks 40. In other words, by utilizing the space formed between the necks 42 of the bottles 4 that are mounted in the tilted state as described above, the tanks 40 and the bottles 4 are disposed so that a height of the tanks 40 and a height of the bottles 4 partially overlap. This disposition makes it possible to reduce a height of the housing 7.

As described later, for example, a bottle replacing robot R1 replace the bottles 4 by accessing a bottle mounting unit 50 including the plurality of bottle mounting stages 5. As described above, the bottle mounting stages 5 are arranged in a matrix in a plane view. The number of the bottle mounting stages 5 disposed in the front-rear direction is greater than the number of the bottle mounting stages 5 disposed in the left-right direction. Therefore, when the bottle replacing robot R1 accesses the bottle mounting unit 50 from the left and right sides respectively, the bottle mounting stages 5 are prevented from being disposed at positions relatively far from the robot R1, and a relatively large number of the bottle mounting stages 5 are disposed near the robot R1. Accordingly, the layout in which the number of the bottle mounting stages 5 disposed in the front-rear direction and the left-right direction is different as described above is advantageous in reducing errors when the bottle replacing robot R1 replaces the bottles 4.

FIG. 7 shows the bottle mounting stages 5 in the first state, and FIG. 8 shows the bottle mounting stages 5 in the second state. As described above, eight bottle mounting stages 5 and eight tanks 40 are arranged and provided on the support body 55. Since these bottle mounting stages 5 and tanks 40 are moved as a unit, they are described as the bottle mounting unit 50. The bottle mounting unit 50 is a component configured to be movable between the inside and outside of the housing 7, and includes the support body 55, the bottle mounting stages 5, the tanks 40, and a mover 6, which is described later. When the bottle mounting unit 50 is in the second state, the tanks 40 are moved to the front side of the cassette station 12 together with the bottles 4. Accordingly, the flow path 36 connecting the tanks 40 and the nozzle 33 is configured to have an appropriate length so as not to interfere with such movement.

The bottle mounting unit 50 is provided with vertical plate-like bodies 57 and 58 on front and rear sides, respectively, in a movement direction of the support body 55. As already described, these plate-like bodies 57 and 58 form the front-rear walls of the housing 7. In this example, when the bottle mounting unit 50 (bottle mounting stages 5) is in the first state, as shown in FIGS. 2 and 7, the front plate-like body 57 is integrated with the front wall 121 of the cassette station 12, and this plate-like body 57 forms a part of the wall of the cassette station 12 (a part of the side wall of the system housing described above).

That is, an opening 120 is formed in the front wall 121 of the cassette station 12 to form a movement region for the bottle mounting unit 50 mounted on the support body 55, and this opening 120 is opened and closed by the plate-like body 57 which serves as a lid. In this way, when the bottle mounting unit 50 is set to the first state, the opening 120 is closed by the plate-like body 57, and the space around each bottle mounting stage 5 is closed by the housing 7.

Further, the inside (space 70) of the housing 7, which is set to the first state and has a closed space inside, is exhausted by an exhauster 75 including a valve, an exhaust pump, and the like as shown in FIG. 4. The reason for exhausting the inside of the housing 7 in this manner is to prevent a vaporized processing liquid from leaking to the outside of the housing 7 when the processing liquid is leaked from the bottle 4, the tank 40, and the flow path associated with the bottle 4 and the tank 40 and vaporized.

The housing 7 includes the top wall 72, the side walls 73 and 74, the plate-like bodies 57 and 58, and the support body 55. As described above, the plate-like body 57 constitutes the lid of the housing 7 and is movable by the mover 6, which is described later. In describing an outline of the housing 7, it is described as if that, among the walls constituting the housing 7, only the plate-like body 57, which serves as the lid, moves. However, as described above, since the plate-like bodies 57 and 58 are each connected to the support body 55, the support body 55 and the plate-like body 58 also move together with the plate-like body 57. The bottle mounting unit 50 supported by the support body 55 also moves together with the support body 55. As described above, some parts of the walls constituting the housing 7 do not move, while other parts of the walls move together with the bottle mounting unit 50 including the bottle mounting stages 5, resulting in the second state in which the space 70 formed by the housing 7 is opened and the bottle mounting stages 5 are located outside the space 70 (i.e., outside the housing).

Next, a description is given of the mover 6 that moves the bottle mounting unit 50 to the outside of the housing 7 in order to switch from the first state to the second state. The mover 6 constitutes the switcher for switching between the first state and the second state. As shown in FIG. 4, for example, both left and right ends of the support body 55 are bent downward near the walls 73 and 74 of the housing 7, thereby forming a space below the support body 55. The mover 6 is disposed in this space.

As shown in FIGS. 4, 7 and 8, the mover 6 includes, for example, a motor 61 provided on a rear side of a lower surface of the support body 55, a pinion gear 62 rotated by the motor 61, and a linear member 63 provided on the bottom wall 71 of the housing 7 in the front-to-rear direction in the region where the bottle mounting unit 50 moves. Accordingly, the mover 6 is positioned lower than each of the bottle mounting stages 5, the bottle disposition areas on the bottle mounting stages 5, and the tanks 40, and is thus positioned at a different height from the bottle mounting stages 5, the bottle disposition areas, and the tanks 40. By providing the mover 6 at such a different height, it is possible to prevent the space in the housing 7 for accommodating the bottles 4 and bottle mounting stages 5 from being reduced, and it is possible to install a sufficient number of bottle mounting stages 5 and tanks 40.

The pinion gear 62 is configured to rotate about a horizontal axis when driven by the motor 61, and the linear member 63 includes, for example, a number of teeth formed at positions corresponding to the pinion gear 62. Thus, when driven by the motor 61, the pinion gear 62 rotates while meshing with the teeth formed on the linear member 63, causing the bottle mounting unit 50 including the support body 55 and the plate-like bodies 57 and 58 connected to the support body 55 to move in the front-rear direction. This front-rear movement causes the switch between the first state and the second state described above.

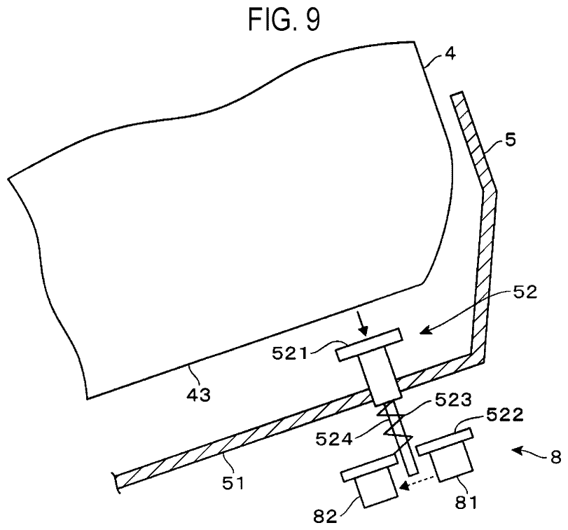

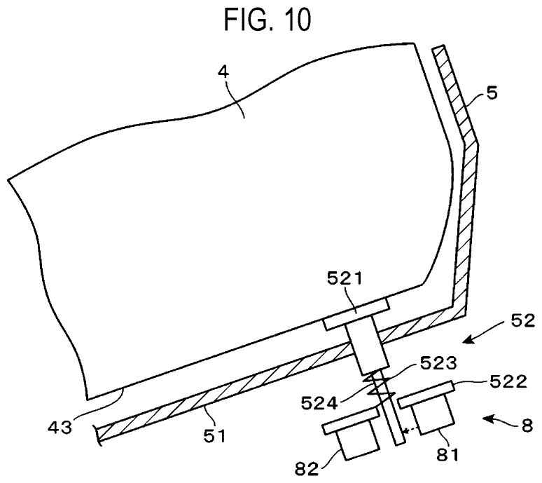

Next, configurations of the first support 52 and the second support 53 provided on each bottle mounting stage 5 of the bottle mounting unit 50 are described with reference to FIGS. 9 and 10. FIGS. 9 and 10 show the first support 52. As shown, the first support 52 includes a contact portion 521 having a T-shape when viewed from a lateral side, and a lower member 522 that is provided below the contact portion 521 and has an inclined surface that faces the bottom surface 51 of the bottle mounting stage 5. A lower end of the contact portion 521 and an upper end of the lower member 522 are connected by an elastic member, such as a spring 523. The contact portion 521 is provided with a rod-shaped body 524 that extends downward inside the spring 523. The rod-shaped body 524 extends in a direction orthogonal to the bottom surface 51, and the contact portion 521 is movable in the orthogonal direction.

FIG. 9 shows a state immediately before the bottle 4 is mounted on the bottle mounting stage 5 and where the bottle 4 is not positioned in the bottle disposition area, while FIG. 10 shows a state in which the bottle 4 is positioned in the bottle disposition area. As shown in FIG. 10, when the bottle 4 is positioned in the bottle disposition area, the contact portion 521 is pressed by the bottom surface 43 of the bottle 4 and the lower end of the contact portion 521 approaches the lower member 522, such that the spring 523 is compressed and a tip of the rod-shaped body 524 is moved down.

On the other hand, as shown in FIG. 9, when the bottle 4 is not positioned in the bottle disposition area, the contact portion 521 is raised above the position shown in FIG. 10 due to restoring force of the spring 523. As a result, the lower end of the contact portion 521 is separated from the lower member 522, and the tip of the rod-shaped body 524 is raised above the position shown in FIG. 10. Thus, the first support 52 corresponds to a moving part configured to be position-changed between a state in which the bottle 4 is positioned in the bottle disposition area and a state in which the bottle 4 is not positioned in the bottle disposition area.

In this example, a detector 8 that detects presence or absence of the bottle 4 in the bottle disposition area is provided for each first support 52. The detector 8 is configured to detect the presence or absence of the bottle 4 according to the position of the moving part, and is provided, for example, on the lower member 522 of the first support 52. In this example, the detector 8 is made up of a light-blocking sensor and includes a light emitter 81 and a light receiver 82. When no bottle 4 is located in the bottle disposition area as shown in FIG. 9, the rod-shaped body 524 is located above an axis of light irradiated by the light emitter 81, and when the bottle 4 is located in the bottle disposition area as shown in FIG. 10, the rod-shaped body 524 is located to block the axis of light.

The light receiver 82 of each detector 8 transmits a detection signal to the controller 100 according to presence or absences of light received, and the controller 100 detects the presence or absence of the bottle 4 in the bottle disposition area based on each detection signal. Specifically, for example, if each light receiver 82 does not detect light reception, it is determined that the bottle is present in the bottle disposition area, and if any light receiver 82 detects light reception, it is determined that the bottle is not present in the bottle disposition area. As described above, the bottle disposition area is an area occupied by the bottles 4 in a normal posture. Therefore, detecting the presence of the bottle in the bottle disposition area means detecting that the bottle 4 is mounted on the bottle mounting stage 5 in the normal posture.

On the other hand, detecting the absence of the bottle in the bottle disposition area means detecting that the bottle 4 is not present on the bottle mounting stage 5, or that the bottle 4 is mounted in an abnormal posture. Specific examples of the abnormal posture are described later. As described above, the detector 8 is provided to detect the presence or absence and posture of the bottle 4 on the bottle mounting stage 5 (more precisely, to detect whether the bottle is mounted in the normal posture).

The second support 53 is configured similarly to the first support 52 except that it does not include the detector 8. Herein, the reason for providing the detector 8 only to the first support 52 is described. As described above, the bottle 4 is mounted on the bottle mounting stage 5 in a tilted state to one of the left and right sides. Therefore, when an abnormality occurs during the delivery of the bottle 4 by the bottle replacing robot R1 (described later) to the bottle mounting stage 5 and the bottle 4 is not mounted normally (the bottle 4 is not located in the bottle disposition area), it is highly likely that the bottle 4 is in a state of being toppled to one of the left and right sides (a posture tilted more than the normal posture). In other words, since the state in which the bottle 4 is mounted normally is a posture in which the bottle 4 is tilted in a predetermined direction (in this example, one of the left and right sides) on the bottle mounting stage, when the bottle 4 is not mounted normally, it is likely that the bottle 4 is further tilted to the predetermined direction.

Even when the bottle 4 is in such a toppled state, the bottle 4 may not fall off the bottle mounting stage 5 if a lower portion of the bottle 4 remains within the side surface 56 of the bottle mounting stage 5 by a side surface of the bottle 4 being supported by an upper end of the bottle mounting stage 5. In other words, although the bottle 4 is mounted on the bottle mounting stage 5, it is conceivable that the bottle 4 may be in an abnormal posture with a greater tilt than the posture shown in FIG. 5. In such an abnormal posture, a distance between the bottom surface 43 of the bottle 4 and the inclined bottom surface 51 of the bottle mounting stage 5 is small on a lower side in the bottle mounting stage 5. Accordingly, the second support 53 provided at a lower side of the bottom surface 51 may come into contact with the bottom surface of the bottle 4 even when the bottle 4 is in such an abnormal posture. In this case, if the second support 53 is also provided with the detector 8, the bottle 4 would be detected as being mounted in a normal posture. However, the above-mentioned distance increases toward an upper side in the bottle mounting stage 5. Accordingly, the bottom surface 43 of the bottle 4 is reliably separated from the first support 52 provided at an upper side of the bottom surface 51.

As described above, providing the detector 8 to the second support 53 would likely result in a failure to detect the abnormal posture of the bottle 4 and a false detection that the bottle 4 is in the normal posture. On the other hand, providing the detector 8 to the first support 52 allows for more reliable detection of the abnormal posture. To improve abnormality detection accuracy and reduce the number of detectors 8 to suppress an increase in a device manufacturing cost, the detector 8 is provided only to the first support 52 of the first support 52 and the second support 53. However, the second support 53 may also be provided with the detector 8. Further, in FIG. 5, there may be a case where two first supports 52 each including a detector 8 are provided in the X direction (depth direction). In this case, when two detectors 8 are provided to produce different detection results (for example, a case of only one detecting light reception), it is possible to detect an abnormal posture in which the bottle 4 is tilted in the depth direction.

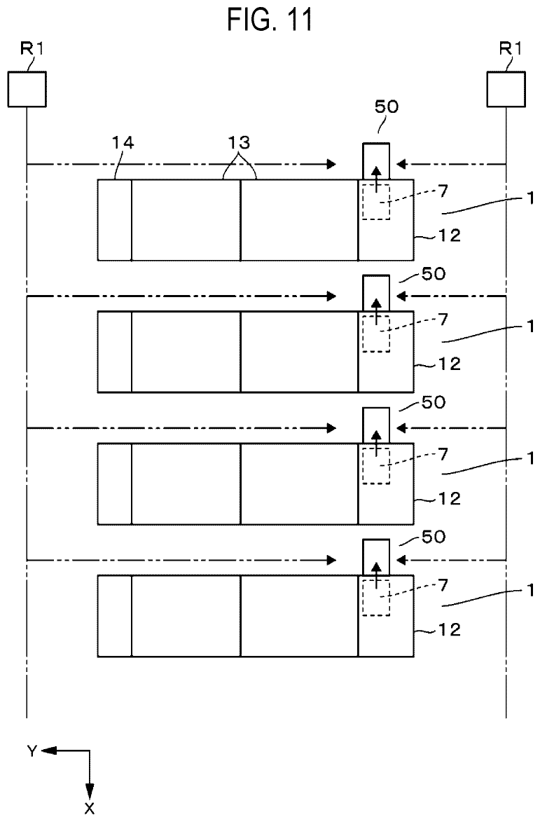

In this example, as shown in FIG. 11, a plurality of, for example, four, wafer processing systems 1 are arranged side by side in the front-rear direction. A certain distance is secured as a maintenance region between adjacent wafer processing systems in the front-rear direction. The maintenance region is set to a size that prevents the adjacent wafer processing systems 1 from interfering with each other when the bottle mounting unit 50 is in the second state.

The bottle replacing robot R1 capable of moving within a clean room, for example, is configured to access each bottle mounting stage 5 of the bottle mounting unit 50 in the second state to replace the bottles 4. In FIG. 11, a movement path of the bottle replacing robot R1 is indicated by a two-dot chain line. The bottle replacing robot R1 accesses the bottles 4 arranged on one side in the left-right direction shown in FIG. 4 from the one side, and accesses the bottles 4 arranged on the other side from the other side, thereby replacing the bottles 4.

Specifically, in this replacement, the empty bottle 4 is received by the bottle replacing robot R1 from the bottle mounting stage 5, and the bottle 4 filled with the processing liquid is mounted on the bottle mounting stage 5 by the bottle replacing robot R1. The cap 44 of the bottle 4 is reattached from the bottle 4 received by the robot R1 to a new bottle 4 mounted on the bottle mounting stage 5 by an attachment mechanism (not shown) provided in the wafer processing system 1 or the bottle replacing robot R1.

As shown in FIGS. 7 and 8, an operation panel 101, which constitutes a part of the controller 100, is provided at, for example, the cassette station 12 of the wafer processing system 1. An operator performs a predetermined operation on the operation panel 101 to operate the mover 6 described in FIG. 4 and switch between the first state and the second state. As shown in FIG. 11, before the bottle replacing robot R1 replaces the bottle 4, the operator operates the operation panel 101 of the wafer processing system 1 in which the bottle 4 needs to be replaced. This changes the wafer processing system 1 from the first state shown in FIG. 7, in which the bottle mounting unit 50 is stored in the housing 7, to the second state shown in FIG. 8, in which the bottle mounting unit 50 is removed from the housing 7. After the bottle 4 is replaced, the operator operates the operation panel 101 to return the second state to the first state. The transition between the first state and the second state may be achieved by the operator transmitting a command signal to the wafer processing system 1 from an operation function part (e.g., a host computer) provided remote from the wafer processing system 1, instead of operating the operation panel 101.

For example, the operation panel 101 displays the presence or absence of the bottle 4 in each bottle disposition area detected by the detector 8 for each bottle mounting stage 5 as described in FIGS. 9 and 10. Therefore, by looking at the display, the operator performs a necessary action, such as switching back to the second state and repositioning the bottle 4, if necessary. The operation panel 101 may only display the presence or absence of light detection obtained by the light receiver 82 of the detector 8, and the operator who have seen this display may determine the presence or absence of the bottle 4 in the bottle disposition area.

According to this embodiment, the mover 6 moves the bottle mounting unit 50 including the bottle mounting stages 5, thereby switching between the first state in which the bottle mounting unit 50 is stored within the housing 7 and the second state in which the bottle mounting unit 50 is taken out from the housing 7 so that it becomes possible to replace the bottle 4. In other words, since the bottle mounting stage 5, which is relatively heavy due to the inclusion of the bottles 4 and tanks 40, does not need to be moved manually to replace the bottle 4, it is possible to reduce burden on the operator in replacing the bottle 4. In the above-described example, the bottle replacing robot R1 replaces the bottle 4. However, the same effects are achieved even when the operator replaces the bottle 4.

Further, in the wafer processing system 1, the space 70 within the housing 7 that accommodates the bottle mounting stage 5 is configured as a space within the system 1. That is, in the first embodiment, the bottle accommodating apparatus is incorporated into the wafer processing system 1. With this configuration, it is possible to reduce an area required to install the wafer processing system 1 and the associated bottle mounting stages 5 compared to a configuration in which the housing 7 is provided separately from the wafer processing system 1, which is described later.

In the above-described example, the housing 7 is disposed, for example, below the region where the wafer transfer device 21 is provided in the cassette station 12. However, the present disclosure is not limited to this example. The housing 7 may be provided below the region where the wafer transfer device 22 is provided, and the bottle mounting stage 5 may be moved to a rear side to set the second state. Further, the present disclosure is not limited to the case where the housing 7 is provided in the cassette station 12, and the housing 7 may be provided in another station such as the processing station 13.

### Second Embodiment

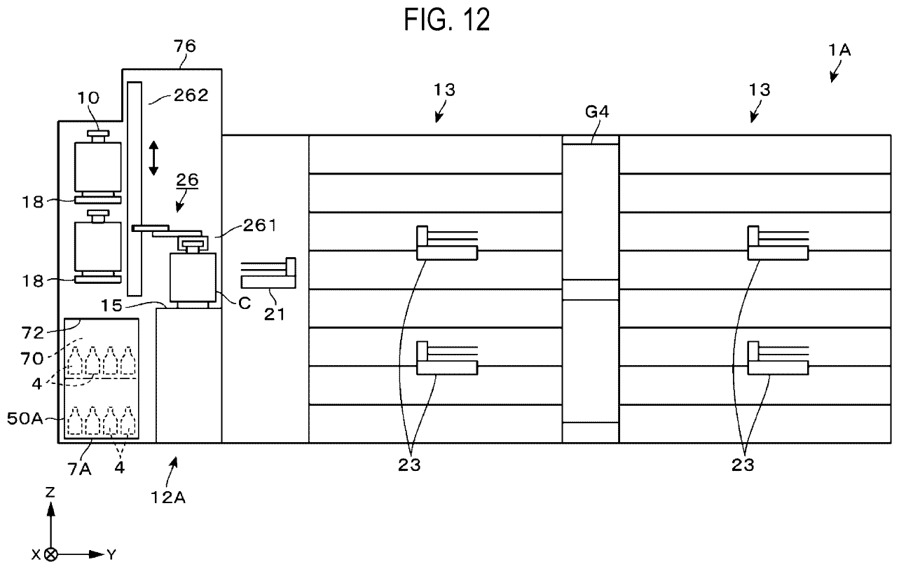

Next, a wafer processing system including a bottle accommodating apparatus according to a second embodiment is described with reference to FIGS. 12 to 15, focusing on configurations different from those of the first embodiment. A wafer processing system 1A according to this embodiment is configured as a stand-alone type without an interface station (i.e., not connected to an exposure apparatus). The cassette station 12A is installed with standby parts 18 for keeping cassettes C in a standby state, as well as a container transferrer 26.

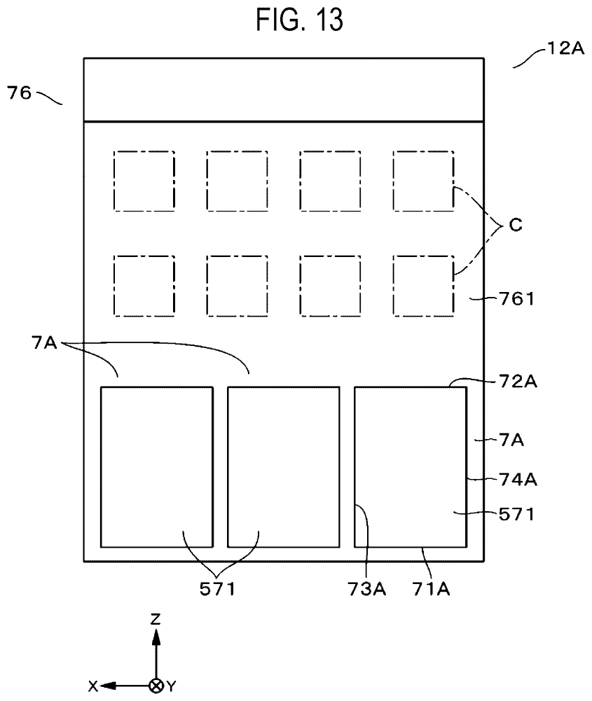

The standby parts 18 are arranged on one side (left side in this example) of the cassette mounting tables 15 in the left-right direction, with two tiers in the up-down direction and four in the front-rear direction. In FIG. 13, the cassettes C waiting in the standby parts 18 are indicated by alternated long and short dash lines. The container transferrer 26 is movable in the X, Y, Z, and θ directions so as to hold the grip portion 10 provided on top of the cassette C with an arm 261 and transfer the cassette C between the standby part 18 and the cassette mounting table 15. In FIG. 12, reference numeral 262 denotes an elevation shaft of the container transferrer 26.

The standby parts 18 and the container transferrer 26 are enclosed in a housing 76 which is a system housing. Accordingly, although the system housing is described as enclosing the wafer transfer device and the processing apparatus in the first embodiment, the housing 76 is formed to enclose not only the wafer transfer device and the processing apparatus, but also a movement region of the cassettes C between the standby parts 18 and the cassette mounting tables 15. Remaining configurations of the cassette station 12A and the processing station 13 are the same as those of the first embodiment.

In this example, a housing 7A surrounding the bottle mounting stages 5 in the first state is disposed in a region below the standby parts 18 of the cassette station 12A. As shown in FIG. 13, when the cassette station 12A is viewed from the left, a plurality of housings 7A, for example, three housings 7A, are provided in the front-rear direction with spaces left between them.

The housing 7A includes the same configuration as the housing 7 and defines a space 70 therein. However, since the bottle mounting unit 50 is pulled out to the left as described below, a portion that serves as a lid corresponding to the plate-like body 57 of the housing 7 is a wall (plate-like body 571 described below) that constitutes a lower portion at a left side of the housing 76. In FIG. 13, a top wall that constitutes the housing 7A is indicated as 72A, and side walls are indicated as 73A and 74A. The top wall 72A and the side walls 73A and 74A are formed separately for each housing 7A within the system housing 76. In this manner, the top wall 72A and the side walls 73A and 74A that form each housing 7A are provided within the system housing 76.

Therefore, the space 70 (the space around the bottle mounting stages 5 in the first state) is provided within the housing 7A, as well as within the system housing 76 (the housing provided at the cassette station 12). Each housing 7A is provided with a bottle mounting unit 50A that is movable in the left-right direction. That is, in the first state, the bottle mounting unit 50A is located in the space 70 within the housing 7A, and in the second state, the bottle mounting unit 50A is moved to the left from the housing 7A.

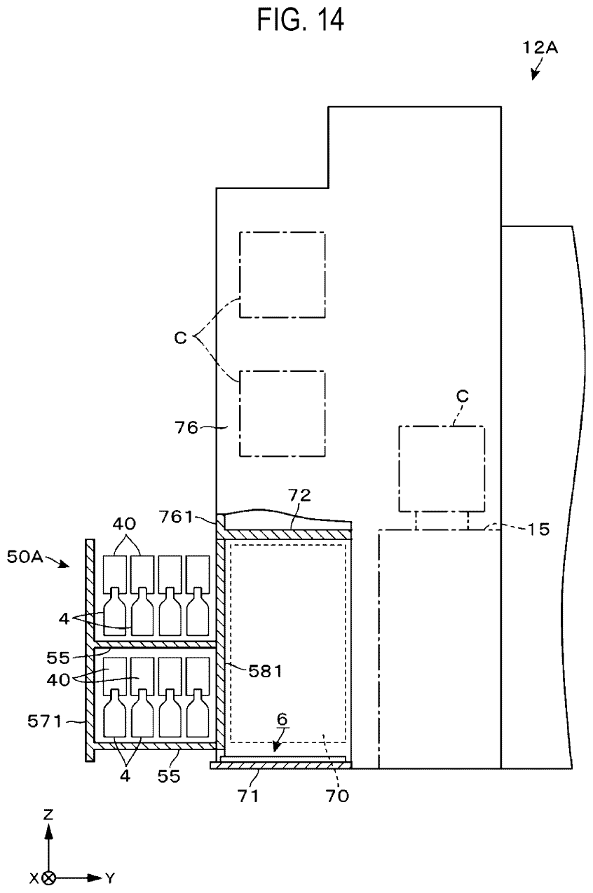

As shown in FIGS. 12 and 14, the bottle mounting unit 50A of this example is configured in the same manner as the bottle mounting unit 50 of the first embodiment, except that the bottle mounting stages 5 are provided in two tiers in the up-down direction. For example, two upper and lower tiers of support bodies 55 are provided, and each of the support bodies 55 is provided with a bottle mounting stage 5 for mounting the bottle 4 in a tilted state and a tank 40. In a direction in which the bottle mounting unit 50A moves, the bottle mounting stages 5 and the tanks 40 of each tier are laid out in the same manner as in the first embodiment.

Therefore, when viewed from the left side of the cassette station 12A, the bottle mounting stages 5 on each tier are provided so that two bottle mounting stages are arranged side by side in the left-right direction and four bottle mounting stages are arranged side by side in the front-rear direction. The tanks 40 are arranged in the same manner as the bottle mounting stages 5. The mover 6 is provided below the support body 55 of the lower tier, and the detector 8 is provided on the first support 52 of each bottle mounting stage 5. Hereinafter, one of the two rows of bottle mounting stages 5 as viewed in the movement direction of the bottle mounting unit 50 or 50A is referred to as a first row, and the other row as a second row.

As shown in FIG. 14, walls 571 and 581 that form front and rear walls of the housing 7A are provided on left and right ends of the support body 55 of each of the bottle mounting units 50A when viewed from the front side of the cassette station 12A. When the bottle mounting unit 50A is in the first state, the wall 571 is configured to be integrated with a left wall 761 of the system housing 76. The walls 571 and 581, the lower support body 55, the top wall 72, and the side walls 73 and 74 form the housing 7A.

As described above, in this example, the space around the bottle mounting stages 5 in the first state is enclosed by the housing 76 that surrounds the standby part 18 and the container transferrer 26. The bottle mounting stage 5 in the first state is disposed in the region below the standby part 18, and a left-right position of the bottle mounting stage 5 in the first state is the same as a left-right position of the standby part 18.

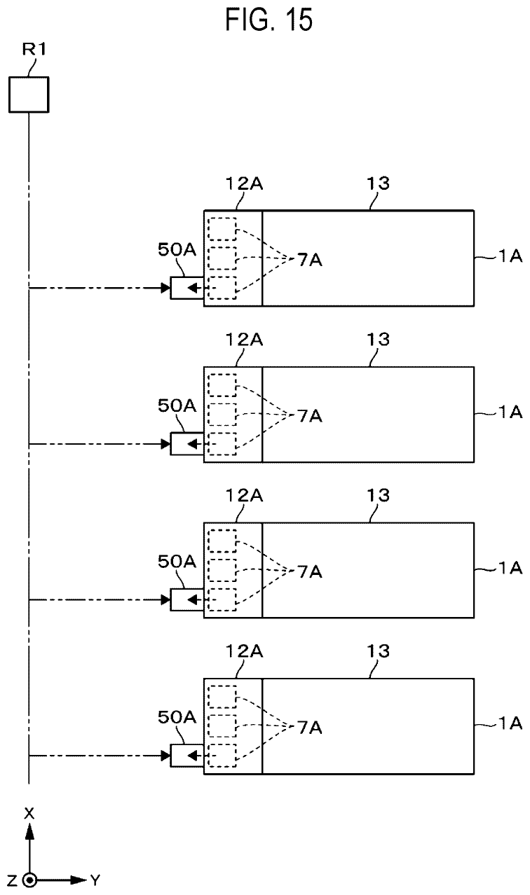

In this example as well, as shown in FIG. 15, a plurality of, for example, four, wafer processing systems 1A are disposed at intervals from one another. As described above, when replacing the bottle 4, the bottle mounting unit 50A is moved leftward from the cassette station 12A and is set to the second state. The bottle replacing robot R1 then accesses the bottle mounting unit 50A in the second state and replaces the bottle 4.

For example, as in the first embodiment, the bottle replacing robot R1 accesses the bottles 4 in the first row from a side of the first row in an arrangement direction of the first and second rows to replace the bottles 4 in the first row, and accesses the bottles 4 in the second row from a side of the second row in the arrangement direction of the first and second rows to replace the bottles 4 in the second row. Detailed movement paths of the robot R1 are not shown in FIG. 15. One wafer processing system 1A is provided with multiple bottle mounting units 50A, but as shown in FIG. 15, a selected one of the bottle mounting units 50 is moved into the second state in which the bottles 4 are deliverable to the bottle mounting stages 5. This prevents one bottle mounting unit 50A from interfering with the robot R1's access to another bottle mounting unit 50A. In the following embodiments, as in the first and second embodiments, the bottle replacing robot R1 accesses the bottle mounting units 50 to replace the bottles 4.

Other configurations are the same as those of the first embodiment. In this embodiment as well, it is possible to reduce the burden on the operator when replacing the bottle 4. Further, in this example, the region below the standby part 18 is used as the housing 7A, which is desirable because it is possible to provide a relatively large number of bottle mounting stages 5 and tanks 40 in the wafer processing system as described above.

### Third Embodiment

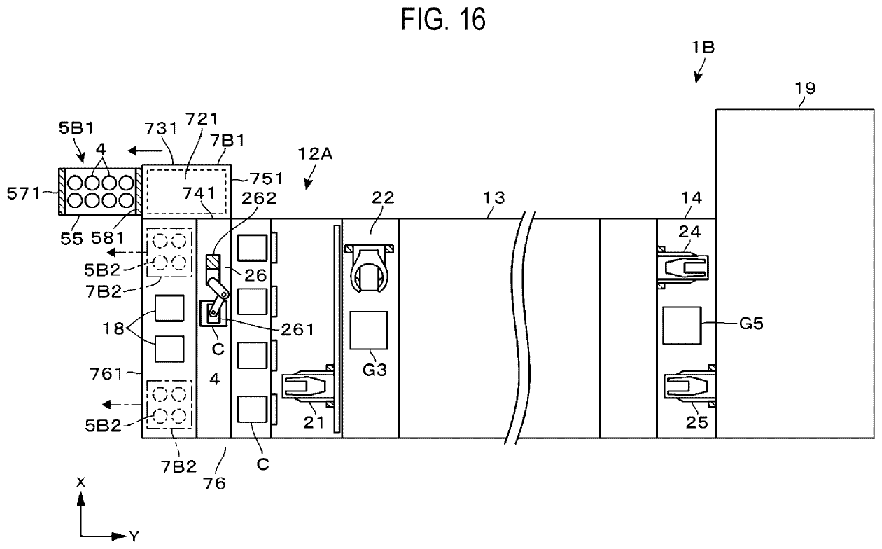

A wafer processing system including a bottle accommodating apparatus according to a third embodiment is described with reference to FIG. 16, focusing on configurations different from those of the previous embodiments. A wafer processing system 1B of this embodiment is configured by connecting an exposure apparatus 19 to the wafer processing system 1A of the second embodiment via an interface station 14. The interface station 14 is configured similarly to that of the first embodiment, and therefore is not described here. As shown in FIG. 16, the cassette station 12A, processing station 13, interface station 14, and exposure apparatus 19 are arranged so that the front positions thereof are aligned with one another. The exposure apparatus 19 is installed to protrude rearward.

In this example, a first housing 7B1 that accommodates the bottle mounting stages 5 is provided to face the rear side of the cassette station 12A in a plane view, and a second housing 7B2 that accommodates the bottle mounting stages 5 is provided in the cassette station 12A. Herein, the first housing 7B1 is provided behind the cassette station 12A in the front-rear direction of the wafer processing system 1B so as to be aligned with a direction in which the exposure apparatus 19 protrudes. More specifically, the first housing 7B1 faces one of front and rear ends of the exposure apparatus 19 in the left-right direction, and faces the cassette station 12A, so that the first housing 7B1 is disposed adjacent to the cassette station 12A.

The second housing 7B2 is provided in the cassette station 12A, for example, in the region below the standby part 18 in FIG. 12. In this figure, the second housing 7B2 is provided in a front region and a rear region in the cassette station 12A. However, the second housing 7B2 may also be provided in a region between the front region and the rear region as in the example of FIG. 13.

The first housing 7B1 is configured similarly to the housing 7, except that it is provided outside the cassette station 12A. That is, the first housing 7B1 includes a bottom wall (not shown), a top wall 721, side walls 731 and 741, and a rear wall 751. A bottle mounting unit 5B1 is accommodated in the first housing 7B1, and the bottle mounting unit 5B1 is configured similarly to, for example, that of the second embodiment described above.

However, the first housing 7B1 is not formed by the partition walls or a portion of the system housing described above, but is formed separately from them. However, just like the housing 7, the first housing 7B1 is able to accommodate the bottle mounting unit 5B1 in the space 70 within the housing in the first state and is able to exhaust the space 70. When the second state is established, the bottle mounting stages 5 are moved out of the space 70 as the lid (wall 571) moves.

The second housing 7B2 is configured similarly to the housing 7A of the second embodiment. In addition, a bottle mounting unit 5B2 is accommodated in the second housing 7B2, and the bottle mounting unit 5B2 is configured similarly to that of the second embodiment described above, except that, for example, the bottles 4 disposed in the left-right direction are two. Thus, the first housing 7B1 and the second housing 7B2 are configured to close the space around the respective bottle mounting stages 5 together with the wall 571 provided on the support body 55 when the bottle mounting stages 5 of the respective bottle mounting units 5B1 and 5B2 are in the first state.

As shown in FIG. 16, the second state of this example is a state in which the bottle mounting units 5B1 and 5B2 have moved from the first housing 7B1 and the second housing 7B2 to the left of the cassette station 12A. Then, a bottle replacing robot (not shown) is configured to access the bottle mounting units 5B1 and 5B2 in the second state from the left side of the cassette station 12A and replace the bottle 4.

Other configurations are the same as those of the first embodiment. In this embodiment as well, it is possible to reduce the burden on the operator when replacing the bottles 4. Further, both bottle mounting units 5B1 and 5B2 are moved to the left of the cassette station 12A and are set to the second state. Accordingly, it is possible to concentrate areas accessed by the bottle replacing robot to be near the cassette station 12A, which makes it possible to efficiently perform the bottle replacement operation.

Herein, disposing a connected body of the wafer processing system 1B and the exposure apparatus 19 as shown in FIG. 16 in a clean room is considered. Other substrate processing systems are provided on both front and rear sides of the connected body. To allow the operator to perform various necessary operations on each system, the connected body is disposed so that a predetermined amount of space is formed between the exposure apparatus 19, which has the largest front-rear width in the connected body, and the other substrate processing systems. Broadly speaking, the connected body is considered to be a rectangular body having a size that encompasses the connected body in a plane view, and the connected body is disposed so that a predetermined amount of space is formed between the rectangular body and the other substrate processing systems. Accordingly, a region facing the protruding exposure apparatus 19 on the rear side of the wafer processing system 1B is a dead space.

However, in this example, by disposing the first housing 7B1 opposite the exposure apparatus 19, the first housing 7B1 is positioned in that dead space. This is desirable because it is possible to provide a relatively large number of bottles 4 for the wafer processing system 1B without affecting the positional relationship between the connected body and other substrate processing systems in a clean room (i.e., without increasing the disposition spacing between them). In this example, the exposure apparatus 19 protrudes rearward relative to the wafer processing system 1B and thud, for the reasons described above, the first housing 7B1 is disposed behind the wafer processing system 1B. If the exposure apparatus 19 protrudes forward relative to the wafer processing system 1B, the first housing 7B1 may be disposed in front of the wafer processing system 1B.

The first housing 7B1 may be disposed opposite another station instead of being disposed opposite the cassette station 12A, and when disposed opposite another station, the first housing 7B1 may be adjacent to that station. However, from the viewpoint of preventing a region accessed by the bottle replacing robot R1 to replace the bottle 4 from being expanded and preventing requiring more time for the replacement, it is desirable to dispose the first housing 7B1 opposite the cassette station 12A where the second housing 7B2 is located as in the example described above.

Further, when the first housing 7B1 is disposed opposite the cassette station 12A, the bottle mounting unit 5B1 is pulled out from the first housing 7B1 in the same direction as the bottle mounting unit 5B2 is pulled out from the second housing 7B2, that is, to the left. In this way, directions in which the bottle mounting units 5B1 and 5B2 are pulled out are desirably matched between the housings. More specifically, when enabling the replacement of the bottles 4 in the first and second rows of the first housing 7B1 located adjacent to the rear side of the cassette station 12, the bottle mounting unit 5B1 may be pulled out in a direction other than the left, i.e., rearward.

However, if the wafer processing system 1B, including the first housing 7B1 and the bottle mounting units 5B1 and 5B2 that are pulled out in different directions, is considered to be a rectangular body as described above, the different pull-out directions may result in the rectangular body being too large. This would limit the installation of the wafer processing system 1B, including the first housing 7B1, in a clean room. In other words, matching the pull-out directions of the bottle mounting units 5B1 and 5B2 is advantageous in preventing such system installation limitations.

Herein, the wafer processing system 1B, which includes the second housing 7B2 and the bottle mounting unit 5B2 stored in the second housing 7B2, is a bottle accommodating apparatus. While the first housing 7B1 and the bottle mounting unit 5B1 stored in the first housing 7B1 accommodate the bottles that store the processing liquid to be supplied to the wafer processing system 1B, they may be regarded as a bottle accommodating apparatus separate from the wafer processing system 1B since the first housing 7B1 and the bottle mounting unit 5B1 are formed outside the wafer processing system 1B.

### Fourth Embodiment

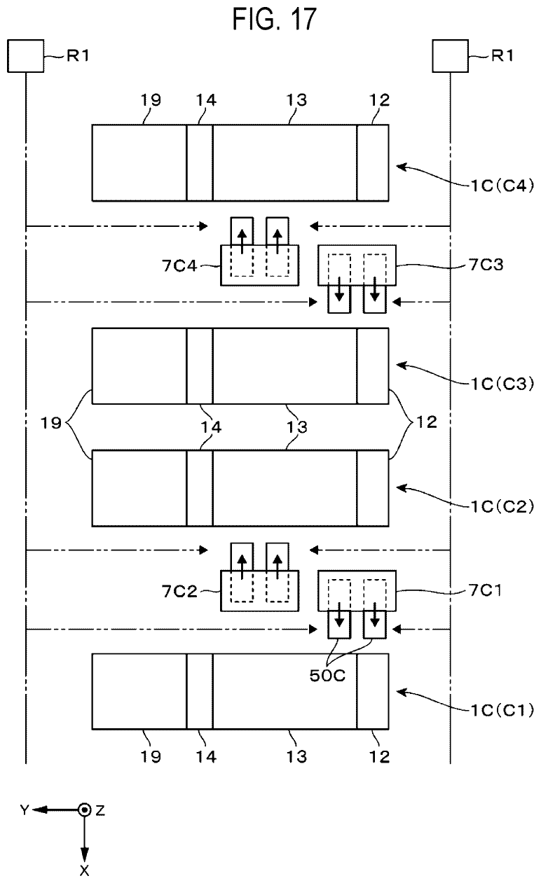

A wafer processing system including a bottle accommodating apparatus according to a fourth embodiment is described with reference to FIG. 17, focusing on configurations different from the previous embodiments. A wafer processing system 1C of this embodiment is an example in which when multiple wafer processing systems 1C are arranged at intervals in the front-rear direction (X direction), a housing 7C and a bottle mounting unit 50C are provided between adjacent wafer processing systems 1C. For example, the wafer processing system 1C is configured by connecting an exposure apparatus 19 to the wafer processing system 1 of the first embodiment.

In this example, four wafer processing systems 1C, i.e., a first system C1, a second system C2, a third system C3, and a fourth system C4 are arranged from the front side in the front-rear direction. Front-rear distances between the first system C1 and the second system C2 and between the third system C3 and the fourth system C4 are set to be greater than a front-rear distance between the second system C2 and the third system C3. In the region where the front-rear distances are set to be greater, a housing 7C is provided to face the cassette station 12 and the processing station 13 on the front side or rear side in a plane view.

In the example shown in FIG. 17, one housing 7C (7C1 to 7C4) is provided for each wafer processing system 1C (C1 to C4) so that the housings 7C face the cassette station 12 and the processing station 13 in a plane view at positions spaced apart from the cassette station 12 and the processing station 13. For example, between the first system C1 and the second system C2, the housing 7C1 for the first system C1 and a housing 7C2 for the second system C2 are arranged in the left-right direction (Y direction). Similarly, between the third system C3 and the fourth system C4, a housing 7C3 for the third system C3 and a housing 7C4 for the fourth system C4 are arranged in the left-right direction.

Each housing 7C includes, for example, two spaces 70 formed by an internal partition wall, and the bottle mounting unit 50C is provided to be stored in each space 70. Accordingly, it may be viewed that one wafer processing system 1C is essentially provided with two housings. By moving forward or backward from each housing 7C, the bottle mounting unit 50C transitions from the first state in which it is located inside the housing 7C to the second state in which it is moved out from the housing 7C.

In this embodiment, the housing 7C may be provided to face, for example, the cassette station 12 or the exposure apparatus 19 in a plane view on the front side or the rear side. Other configurations are the same as those of the first embodiment. In this embodiment as well, it is possible to reduce the burden on the operator when replacing the bottle 4. In this embodiment, the housing 7C and the bottle mounting unit 50C provided within the housing 7C constitute the bottle accommodating apparatus, and therefore, the bottle accommodating apparatus is configured as a separate apparatus from the wafer processing system 1C. In other words, the bottle accommodating apparatus is not limited to being incorporated into the wafer processing system.

### Fifth Embodiment

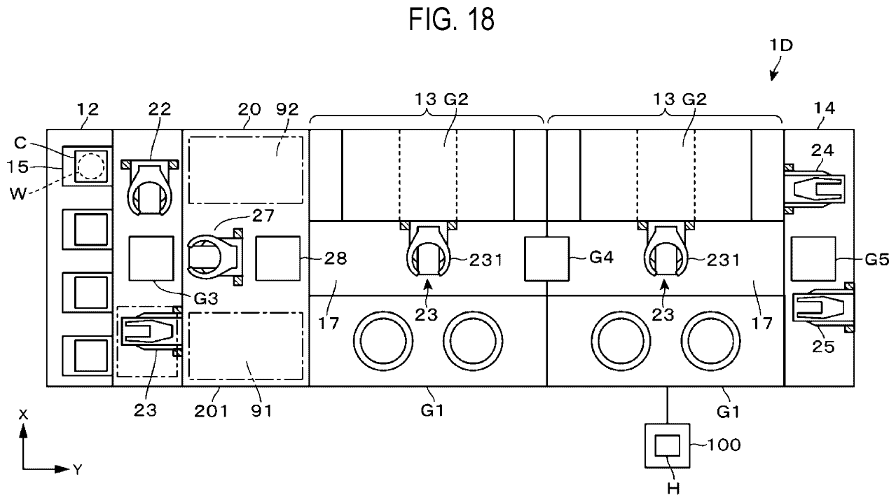

A wafer processing system including a bottle accommodating apparatus according to a fifth embodiment is described with reference to FIGS. 18 to 23, focusing on configurations different from the previous embodiments. A wafer processing system 1D of this embodiment is configured by adding an intermediate station 20, which constitutes an intermediate block, between the cassette station 12 and the processing station 13 in the wafer processing system 1 of the first embodiment. The intermediate station 20 includes a transferrer 27 and a delivery part 28. The transferrer 27 is configured to transfer the wafers W to and from the delivery device in the third block G3 of the cassette station 12. The delivery part 28 is also configured to deliver the wafers W to and from the wafer transfer device 23 in the processing station 13.

In this way, the intermediate station 20 has a function of transferring the wafers W between the cassette station 12 and the processing station 13. A transfer region constituted by, for example, the transferrer 27 and the delivery part is provided at an approximate center in the front-to-rear direction of the intermediate station 20. Further, in front of and behind the transfer region in a plane view, a first space 91 and a second space 92 each provided with the bottle mounting stages 5 are provided. The first space 91 and the second space 92 are configured similarly to each other.

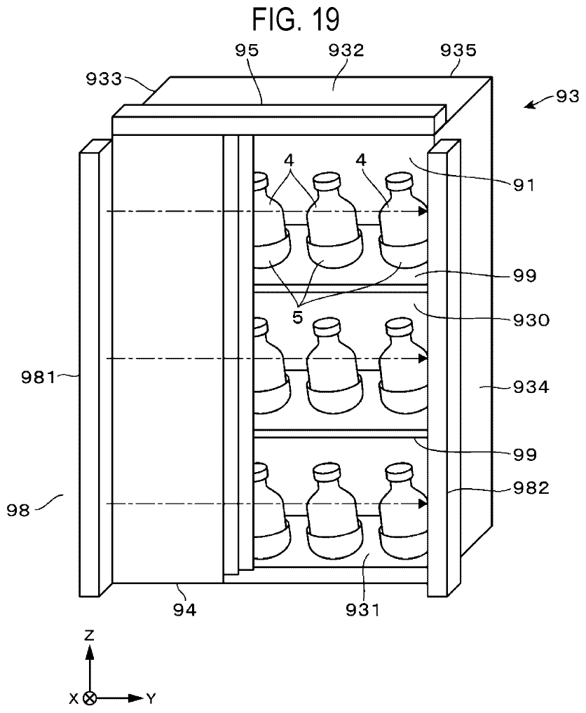

FIG. 19 shows an example of a configuration of the first space 91. The first space 91 is, for example, configured as an internal space of a storage shelf 93, which is a housing. The storage shelf 93 includes, for example, a door part 94, which is provided on its front surface and aligned with a front side wall 201 of the intermediate station 20, and includes a bottom wall 931, a top wall 932, side walls 933 and 934, and a rear wall 935. The door part 94 opens and closes an opening 930 formed across the entire front surface of the storage shelf 93. For example, the rear wall 935 is a partition wall provided within a system housing of the intermediate station 20. The bottom wall 931, the top wall 932, the side walls 933 and 934, and the door part 94 constitute walls of the system housing.

In this example, three shelf portions 99 are provided along the up-down direction inside the storage shelf 93 with the lower shelf being defined by the bottom wall 931. On each shelf portion 99, a plurality of bottle mounting stages 5 are disposed in a row in the left-right direction (Y direction) in this example. The bottle mounting stage 5 is configured similarly to that of the first embodiment, and includes the first support 52, the second support 53, and the detector 8. The bottle mounting stage 5 is configured so that the bottle 4 is mounted in the bottle disposition area with its upper portion tilted forward.

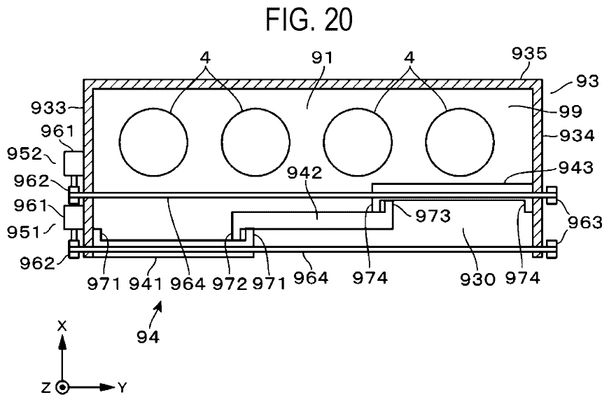

As schematically shown in FIGS. 20 to 22, the door part 94 includes a plurality of doors, for example, three doors 941, 942, and 943, which are provided at different positions in the front-rear direction. These doors 941 to 943 are configured to move in the left-right direction. When these doors 941 to 943 are referred to as a first door 941, a second door 942, and a third door 943 from the front side to the rear side, door movers 951 and 952 are provided on either an upper surface or a lower surface of the first door 941 and the third door 943, respectively. In FIG. 19, these are collectively shown as a door mover 95.

The door movers 951 and 952 are provided, for example, on one side of the first door 941 and the third door 943 in the left-right direction and include a driver pulley 962 rotated by a motor 961, a driven pulley 963 provided on the other side of the first door 941 and the third door 943, and a timing belt 964 stretched between the driver pulley 962 and the driven pulley 963. In this way, depending on a rotation direction of the motor 961, the first door 941 and the third door 943 moves from the left to the right or from the right to the left.

Further, for example, a bent portion 971 that bends backward is formed on both ends of the first door 941, a bent portion 972 that bends forward is formed on a left end of the second door 942, a bent portion 973 that bends backward is formed on a right end of the second door 942, and a bent portion 974 that bends forward is formed on both ends of the third door 943. The bent portions 971 and 972 or 973 and 974 are configured to fit together between the first door 941 and the second door 942, and between the second door 942 and the third door 943, respectively.

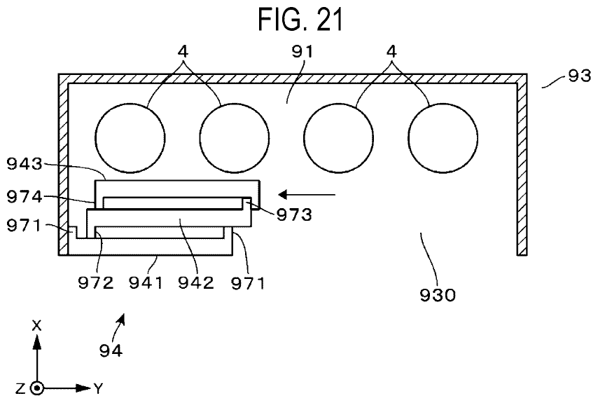

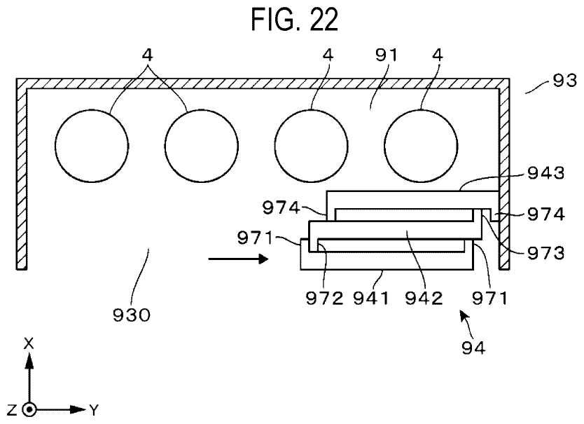

In this way, by driving the first door 941 and the third door 943, a state is created in which the opening 930 of the storage shelf 93 is closed, as shown in FIG. 20. Further, by driving the third door 943 from the right to the left as shown in FIG. 21, the second door 942 moves in conjunction with the movement of the third door 943, and then the first door 941 moves to create a state in which a right side of the opening 930 is opened. Then, by driving the first door 941 from the left to the right as shown in FIG. 22, the second door 942 moves in conjunction with the movement of the first door 941, and then the third door 943 moves to create a state in which a left side of the opening 930 is opened.

In this example, as shown in FIG. 20, the state in which the opening 930 is closed by the door part 94 corresponds to the first state in which the space (first space 91) around the bottle mounting stages 5 is closed. Further, as shown in FIGS. 21 and 22, the state in which the opening 930 is partially open corresponds to the second state in which the space (first space 91) is open so that the bottle 4 is delivered to and from the bottle mounting stage 5. Accordingly, the door movers 951 and 952 that move the doors 941 and 943 correspond to switchers that switch between the first state and the second state. As shown in FIG. 20, an exhauster (not shown) is provided to exhaust an inside of the storage shelf 93 when the opening 930 is closed by the door part 94 and the first state is set.

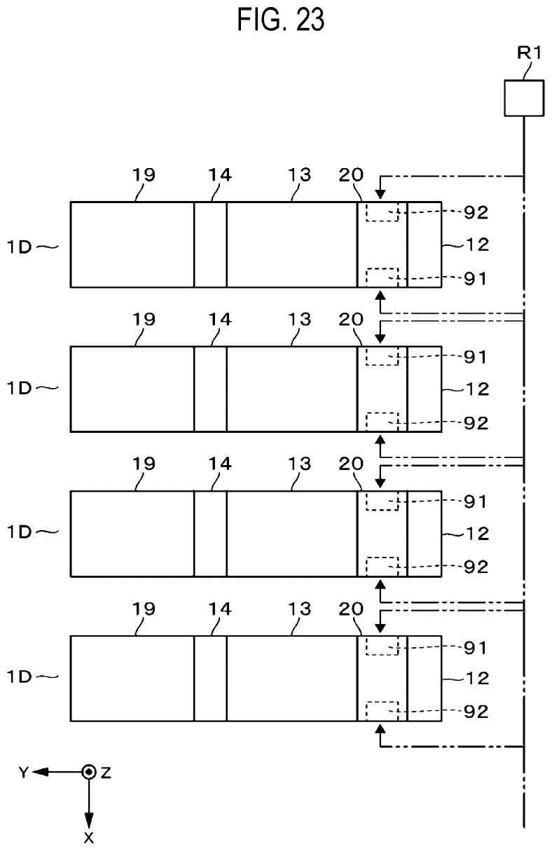

The second space 92 is configured similarly to the first space 91, and is configured so that the first space 91 and the second space 92 are individually switched between the first state and the second state. For example, when an operator operates the operation panel 101, an opening command is output to the door movers 951 and 952 of the door part 94 depending on the bottle 4 to be replaced, so that the door part 94 is automatically moved to the positions shown in FIG. 21 or 22. Then, as shown in FIG. 23, for example, the bottle replacing robot R1 whose movement range is set on one side of the wafer processing system 1D in the left-right direction moves to the first space 91 or the second space 92 where the bottle 4 to be replaced is accommodated, and performs the replacement operation for the bottle 4.

Further, in this example, as shown in FIG. 19, a detector 98 for an interfering object may be provided in front of the door part 94 of the storage shelf 93. This detector 98 includes a light emitter 981 provided at one of left and right ends (the left end in this example) of the storage shelf 93, and a light receiver 982 provided at the other end (the right end in this example). Multiple pairs of light emitter 981 and light receiver 982 are arranged in the up-down direction. When light from the light emitter 981 is blocked, it is determined that an interfering object is present, and the opening and closing of the door part is stopped.

In this embodiment as well, the switcher switches between the first state and the second state when replacing the bottle 4, thereby reducing the burden on the operator in replacing the bottle 4. Further, since the switching between the first state and the second state is performed by opening and closing the door part 94 of the storage shelf 93, this is applicable when, for example, the wafer processing systems 1C are arranged in the front-rear direction and a distance to the adjacent wafer processing system 1C is short.

In this example, the door part 94 of the storage shelf 93 does not have to be configured to slide in the left-right direction as in the above-described embodiment, but may be configured to slide in the up-down direction, or may be configured like a roll screen. Further, in the wafer processing system of FIG. 18, for example, the housing 7 and the bottle mounting unit 50 of the first embodiment may be provided in the region where the first space 91 and the second space 92 are formed in the intermediate station 20, and the bottle mounting unit 50 may be configured to be moved between the first state and the second state by the mover 6.

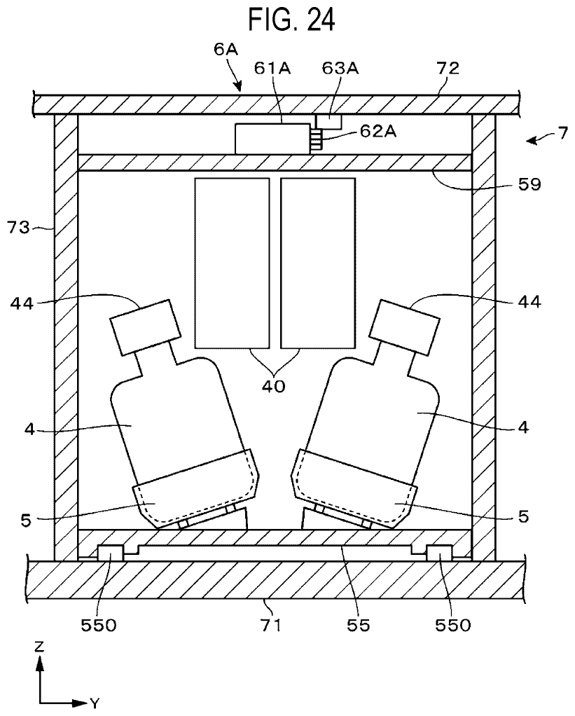

In the above configuration, a mover 6A of the bottle mounting stage 5 may be provided above the bottle mounting stage 5 and the bottle disposition area on the bottle mounting stage 5 as shown in FIG. 24. In this example, a wall 59 facing the support body 55 is provided above the tank 40, and the mover 6A is provided between the wall 59 and the top wall 72 of the housing 7. As shown in FIG. 24, the mover 6A includes a motor 61A, a pinion gear 62A, and a linear member 63A extending along the front-rear direction and including multiple teeth formed thereon to mesh with the pinion gear 62A. The motor 61A and the pinion gear 62A are provided on an upper surface of the wall 59, and the linear member 63A is installed on a lower surface of the top wall 72 of the housing 7. Further, for example, lower surfaces of both left-right ends of the support body 55 are configured to move along guide rails 550.

A configuration of the mover that moves the bottle mounting stage 5 is not limited to the configuration of the movers 6 and 6A. When transmitting power of the motor to the bottle mounting unit 50, which is the object to be moved, other transmission mechanisms, such as a ball screw, may be used instead of the gears. Regarding the door movers 951 and 952 shown in the fifth embodiment, when transmitting the power of the motor to the door, which is the object to be moved, a transmission mechanism other than the belt may also be used. Incidentally, the bottle mounting stage 5 is not limited to being moved relative to the housing 7, and the mover 6 may be configured to move the housing 7 relative to the bottle mounting stage 5. In addition, although the tank 40 moves together with the bottle mounting stage 5 in each of the above examples, a configuration in which only the bottle mounting stage 5 moves may also be adopted.

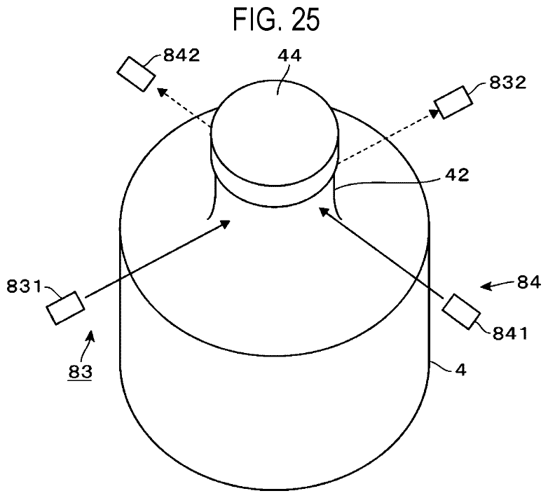

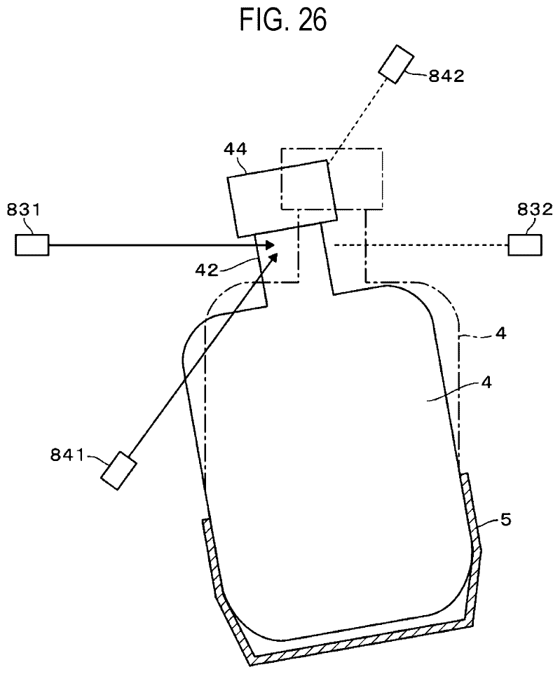

Further, the detector for detecting the presence or absence of the bottle 4 in the bottle disposition area is not limited to the configuration shown in FIGS. 8 to 10. For example, the detector may be a limit sensor, a reflection sensor, or a beam sensor. An example using a beam sensor is described with reference to FIGS. 25 and 26. The beam sensor in this example includes a first detector 83 and a second detector 84. Each of the first detector 83 and the second detector 84 includes a set of light emitters 831 and 841 and light receivers 832 and 842. The light emitter 831 of the first detector 83 and the light emitter 841 of the second detector 84 are respectively positioned so that they emit light from different directions in a plane view toward the neck 42 of the bottle 4 in the bottle disposition area. Optical axes of these two light emitters 831 and 841 are set at different heights to prevent light interference.

For example, the controller 100 constitutes a determiner that determines the presence or absence of the bottle 4 in the bottle disposition area based on light reception of the light receiver 832 of the first detector 83 and the light receiver 842 of the second detector 84. In FIG. 26, the solid line indicates a state in which the bottle 4 is normally disposed in the bottle disposition area. In this case, the optical axes of the two light emitters 831 and 841 are blocked by the neck 42 of the bottle 4, and neither of the two light receivers 832 and 842 receives light.

In FIG. 26, the alternated long and short dash line indicates an example of a state in which the bottle 4 is in an abnormal posture (the bottle 4 is on the bottle mounting stage 5 but not in the bottle disposition area which is a normal area). In this case, the optical axis of one light emitter 831 is blocked by the neck 42 of the bottle 4, but the optical axis of the other light emitter 841 is not blocked. As a result, one of the two light receivers 832 and 842 receives light, while the other does not. Further, when there is no bottle 4 on the bottle mounting stage 5, the optical axes of the two light emitters 831 and 841 are not blocked by the bottle 4, and the light is received by both light receivers 832 and 842.

Therefore, for example, when detection results of both the first detector 83 and the second detector 84 are “light received,” the controller 100 determines that “the bottle is absent.” Further, when the detection result of one of the first detector 83 and the second detector 84 is “light received” and the other is “no light received,” the controller 100 determines that “the bottle is in an abnormal posture.” Moreover, when the detection results of both the first detector 83 and the second detector 84 are “no light received,” the controller 100 is configured to determine that “the bottle is present in a normal posture.” These determination results are displayed on the operation panel 101, for example.

However, depending on a degree of abnormality in the posture of the bottle 4, the detection results of both the first detector 83 and the second detector 84 may be either “light received” or “no light received.” Therefore, the number of the detectors may be increased to more accurately distinguish between the bottle 4 being absent on the bottle mounting stage 5 and the bottle 4 being present on the bottle mounting stage 5 in an abnormal posture.

A case where the first detector 83 and the second detector 84 irradiate light toward the body 41 of the bottle 4 is assumed. In this case, since the body 41 has a larger volume than the neck 42, even if the bottle 4 is tilted relative to the bottle disposition area and is in an abnormal posture, there is a high possibility that optical paths of the first detector 83 and the second detector 84 are blocked as in the case where the bottle is in a normal posture. In other words, the reason why the first detector 83 and the second detector 84 irradiate light toward the neck 42 of the bottle 4 in the bottle disposition area is to enable detection of the abnormal posture of the bottle 4 as described above.

Instead of the controller 100 making the above-described determinations based on the detection results of the first detector 83 and the second detector 84, the operator may make each determination. That is, the operation panel 101 may be configured to display whether or not the light receivers 832 and 842 of the first detector 83 and the second detector 84 have received light, and the operator may make a determination based on that display.

Although the configuration of the wafer processing system to which the bottle accommodating apparatus is applied differs among the above-described embodiments, the configuration of the wafer processing system in each embodiment is arbitrary. Therefore, the configurations may be interchanged, combined, or modified as appropriate among the embodiments. Therefore, for example, the wafer processing system described as the stand-alone system may be configured as a non-stand-alone system, and the wafer processing system described as the non-stand-alone system may be configured as a stand-alone system. The container transferrer 26 described in the second embodiment may be applied to other embodiments.

The semiconductor device for which the processing liquid is used to manufacture the semiconductor device is not limited to a device manufactured from a semiconductor wafer, but also includes a flat panel display (FPD). This technique is also applicable to bottle accommodating apparatuses that store a processing liquid for processing an FPD substrate.

According to the present disclosure in some embodiments, it is possible to reduce burden on an operator when delivering a bottle to and from a bottle mounting stage on which a bottle storing a processing liquid is mounted.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A bottle accommodating apparatus, comprising:
a bottle mounting stage on which a bottle storing a processing liquid for manufacturing a semiconductor device is mounted; and
a switcher configured to switch between a first state in which a space around the bottle mounting stage is closed and a second state in which the space is open so that the bottle is delivered to and from the bottle mounting stage.

2. The bottle accommodating apparatus of claim 1, further comprising:
a housing configured to surround the bottle mounting stage in the first state; and
a mover constituting the switcher and configured to move the bottle mounting stage and the housing relative to each other so that the bottle mounting stage is located outside the housing in the second state.

3. The bottle accommodating apparatus of claim 2, wherein the mover moves the bottle mounting stage laterally relative to the housing, and
wherein the mover is provided above or below the bottle mounting stage and a bottle disposition area on the bottle mounting stage.

4. The bottle accommodating apparatus of claim 1, further comprising:
a processing block provided with a liquid processor configured to receive the processing liquid and perform liquid processing on a substrate; and
a substrate loading/unloading block including a container mount on which a container for storing the substrate is mounted, and a transferrer configured to deliver the substrate to and from the container on the container mount, the substrate loading/unloading block provided on one of left and right sides of the processing block to transfer the substrate between the container and the processing block,
wherein the space around the bottle mounting stage in the first state is a space within a housing provided in the substrate loading/unloading block.

5. The bottle accommodating apparatus of claim 4, wherein the substrate loading/unloading block includes a standby part provided on one of left and right sides of the container mount and configured to keep the container in a standby state, and a container transferrer configured to transfer the container between the container mount and the standby part,
wherein the housing surrounds the standby part and the container transferrer, and
wherein a left-right position of the bottle mounting stage in the first state is the same as a left-right position of the standby part.

6. The bottle accommodating apparatus of claim 1, further comprising:
a processing block provided with a liquid processor configured to receive the processing liquid and perform liquid processing on a substrate; and
a substrate loading/unloading block including a container mount on which a container for storing the substrate is mounted, and a transferrer configured to deliver the substrate to and from the container on the container mount, the substrate loading/unloading block provided on one of left and right sides of the processing block to transfer the substrate between the container and the processing block,
wherein a housing is provided to surround the bottle mounting stage in the first state, and
wherein the housing is provided to face the substrate loading/unloading block in front of or behind the substrate loading/unloading block in a plane view.

7. The bottle accommodating apparatus of claim 6, wherein the housing includes a first housing provided to face the substrate loading/unloading block in front of or behind the substrate loading/unloading block in a plane view, and a second housing provided in the substrate loading/unloading block, and
wherein the bottle mounting stage respectively located in the first housing and the second housing in the first state is located on one of left and right sides of the first housing and the second housing in the second state.

8. The bottle accommodating apparatus of claim 1, further comprising:
a processing block provided with a liquid processor configured to receive the processing liquid and perform liquid processing on a substrate;
a substrate loading/unloading block including a container mount on which a container for storing the substrate is mounted, and a transferrer configured to deliver the substrate to and from the container on the container mount, the substrate loading/unloading block provided on one of left and right sides of the processing block to transfer the substrate between the container and the processing block; and
an intermediate block provided between the substrate loading/unloading block and the processing block and configured to include a transfer region for the substrate,
wherein a first space and a second space each including the bottle mounting stage are provided in front of and behind the transfer region, respectively, and the first state and the second state are switched individually in the first space and the second space.

9. The bottle accommodating apparatus of claim 1, further comprising:
a moving part whose position is changed between a state in which the bottle is located in a bottle disposition area on the bottle mounting stage and a state in which the bottle is not located in the bottle disposition area; and
a detector configured to detect presence or absence of the bottle in the bottle disposition area according to the position of the moving part.

10. The bottle accommodating apparatus of claim 9, wherein the bottle mounting stage includes an inclined surface configured to face a bottom surface of the bottle and mount the bottle in a tilted state, and a first support and a second support provided at different heights on the inclined surface and configured to respectively support the bottom surface of the bottle, and
wherein, of the first support and the second support, only the first support provided at a higher position than the second support constitutes the moving part whose position change is detected by the detector.

11. The bottle accommodating apparatus of claim 1, wherein the bottle includes a body and a neck located above the body and having an outer shape narrower than an outer shape of the body so as to form a step with the body,
wherein a first detector and a second detector each including a set of a light emitter and a light receiver are provided, and
wherein each of the light emitter of the first detector and the light emitter of the second detector emit light toward the neck of the bottle in a bottle disposition area on the bottle mounting stage from mutually different directions in a plane view.

12. A bottle accommodating method, comprising:
mounting a bottle storing a processing liquid for manufacturing a semiconductor device on a bottle mounting stage; and
switching, by a switcher, between a first state in which a space around the bottle mounting stage is closed and a second state in which the space is open so that the bottle is delivered to and from the bottle mounting stage.
